(19) United States
(12) Patent Application Publication
(10) Pub. No.: US 2026/0225942 A1
(43) Pub. Date: Aug. 6, 2026

(54) GLASS

(71) Applicant: AGC Inc., Tokyo (JP)

(72) Inventors: Takeyuki KATO, Tokyo (JP); Shusaku AKIBA, Tokyo (JP)

(73) Assignee: AGC Inc., Tokyo (JP)

(21) Appl. No.: 19/570,385

(22) Filed: Mar. 18, 2026

Related U.S. Application Data
(63) Continuation of application No. PCT/JP2024/030192, filed on Aug. 26, 2024.

(30) Foreign Application Priority Data
Sep. 20, 2023 (JP) 2023-152237

(51) Int. Cl. C03C 3/095; H02S 40/20

(52) U.S. Cl. CPC C03C 3/095; H02S 40/20; C03C 2217/73

(57) ABSTRACT

A glass, having a specific gravity of 2.2 to 2.7, having a Young's modulus of 60 GPa or more, having an average thermal expansion coefficient in a range of 50° C. to 200° C. of 2.0 to 6.0 (×10/K), having a rectangular shape, having a main surface with one side of 50 cm or more and 300 cm or less, having a thickness of 0.01 mm or more and 0.5 mm or less, having a total content of Li₂O, Na₂O, and K₂O of 0% to 3.5% in terms of mass % based on oxides, and containing 0.1% to 10% of CeO₂ in terms of mass % based on oxides.

### CROSS-REFERENCE TO RELATED APPLICATIONS

This is a continuation of International Application No. PCT/JP/2024/030192 filed on Aug. 26, 2024, and claims priority from Japanese Patent Application No. 2023-152237 filed on Sep. 20, 2023, the entire content of which is incorporated herein by reference.

### TECHNICAL FIELD

The present invention relates to a glass, and particularly to a glass suitable as a solar cell cover glass for use in a space satellite, a UV-blocking glass, an electron-beam shielding glass, or the like.

### BACKGROUND ART

The satellite constellation is a method of implementing a function or a service by linking a plurality of satellites, ranging from several hundreds to several thousands of satellites. Since a plurality of satellites are required to construct the satellite constellation, a reduction in cost of the satellites is required. Solar power generation using solar cells has been studied as a power supply source for the satellites. Silicon is generally used for solar cells, and a cover glass for protecting elements is used for solar cells.

As the cover glass for space solar cells, for example, Patent Literature 1 discloses a borosilicate glass composition suitable for use as a solar cell protective cover for use in artificial satellites. In addition, Patent Literature 2 discloses a glass substrate for space solar power generation.

### CITATION LIST

### Patent Literature

Patent Literature 1: JPS63-95138A
Patent Literature 2: WO 2023/022074

### SUMMARY OF INVENTION

### Technical Problem

In particular, when a glass is for use in space solar cells, a low cost of satellites is required. From the viewpoint of cost reduction, a reduction in cost and a reduction in weight can be realized by an increase in size and a reduction in thickness of the glass. On the other hand, due to the increase in size and the reduction in thickness of the glass, it is assumed that warpage of the solar cell is larger than that of a product in the related art due to a difference in thermal expansion coefficient between silicon used for the solar cell and the glass. In addition, there is a problem that mechanical properties and optical properties are insufficient as compared with the product in the related art due to the thinning of the glass.

Therefore, an object of the present invention is to provide a glass capable of preventing a decrease in mechanical properties and optical properties while preventing warpage of a solar cell even in the case where the size is increased and the thickness is reduced.

### Solution to Problem

The inventors of the present invention have found that the above problems can be solved by setting a composition of a glass to a specific range, and have completed the present invention. That is, the present invention is as follows.

1. A glass, having a specific gravity of 2.2 to 2.7,
having a Young's modulus of 60 GPa or more,
having an average thermal expansion coefficient in a range of 50° C. to 200° C. of 2.0 to 6.0 (×10⁻⁶/K),
having a rectangular shape,
having a main surface with one side of 50 cm or more and 300 cm or less,
having a thickness of 0.01 mm or more and 0.5 mm or less,
having a total content of Li₂O, Na₂O, and K₂O of 0% to 3.5% in terms of mass % based on oxides, and
containing 0.1% to 10% of CeO₂ in terms of mass % based on oxides.

2. The glass according to the above 1, further containing, in terms of mass % based on oxides: 0.01% to 10% of TiO₂.

3. The glass according to the above 1, further containing, in terms of mass % based on oxides: 5% to 10% of TiO₂.

4. A glass, having a specific gravity of 2.2 to 2.7,
having a Young's modulus of 60 GPa or more,
having an average thermal expansion coefficient in a range of 50° C. to 200° C. of 2.0 to 6.0 (×10⁻⁶/K),
having a rectangular shape,
having a main surface with one side of 50 cm or more and 300 cm or less,
having a thickness of 0.01 mm or more and 0.5 mm or less, and
containing 5% to 10% of TiO₂ in terms of mass % based on oxides.

5. A glass containing, in terms of mass % based on oxides:
50% to 80% of SiO₂;
0% to 25% of B₂O₃;
0% to 30% of Al₂O₃; and
0.1% to 10% of CeO₂, and
having a total content of Li₂O, Na₂O, and K₂O of 0% to 3.5%,
having a rectangular shape,
having a main surface with one side of 50 cm or more and 300 cm or less, and
having a thickness of 0.01 mm or more and 0.5 mm or less.

6. A glass containing, in terms of mass % based on oxides:
50% to 80% of SiO₂;
0% to 25% of B₂O₃;
0% to 30% of Al₂O₃; and
5% to 10% of TiO₂, and
having a total content of Li₂O, Na₂O, and K₂O of 0% to 3.5%,
having a rectangular shape,
having a main surface with one side of 50 cm or more and 300 cm or less, and
having a thickness of 0.01 mm or more and 0.5 mm or less.

7. A glass containing, in terms of mass % based on oxides:
50% to 80% of SiO₂;
0% to 25% of B₂O₃;
0% to 30% of Al₂O₃;
0.01% to 10% of TiO₂; and
0.1% to 10% of CeO₂, and
having a total content of Li₂O, Na₂O, and K₂O of 0% to 3.5%,
having a rectangular shape,
having a main surface with one side of 50 cm or more and 300 cm or less, and
having a thickness of 0.01 mm or more and 0.5 mm or less.

8. The glass according to any one of the above 5 to 7, having an average thermal expansion coefficient in a range of 50° C. to 200° C. of 2.0 to 6.0 (×10⁻⁶/K).

9. The glass according to any one of the above 1 to 7, having a total content of As₂O₃ and Sb₂O₃ of 0% or more and less than 0.25% in terms of mass % based on oxides.

10. The glass according to any one of the above 1 to 7, further containing, in terms of mass % based on oxides: 0.01% to 0.4% of SnO₂.

11. The glass according to any one of the above 1 to 7, having a content of BaO of 0% or more and 6.5% or less in terms of mass % based on oxides.

12. The glass according to any one of the above 1 to 7, having an average absorbance change amount in a wavelength range of 400 nm to 800 nm during electron beam irradiation of 0.01 or less in terms of a thickness of 100 μm.

13. The glass according to any one of the above 1 to 7, having a fracture toughness value (K_{IC}) of 0.78 MPa·m^{1/2} or more.

14. The glass according to any one of the above 1 to 7, having a value obtained by subtracting a light transmittance at a wavelength of 300 nm from a light transmittance at a wavelength of 400 nm of 50% or more.

15. The glass according to any one of the above 1 to 7, having a value E/ρ obtained by dividing a Young's modulus E (GPa) by a specific gravity ρ of 27.0 GPa or more.

16. The glass according to any one of the above 1 to 7, having a β-OH of 1.0 mm⁻¹ or less.

17. The glass according to any one of the above 1 to 7, including: a conductive film on at least one surface.

18. The glass according to any one of the above 1 to 7, including: an antireflection film on at least one surface.

19. A solar cell cover glass for a space satellite, containing: the glass according to any one of the above 1 to 7.

20. A UV-blocking glass, containing: the glass according to any one of the above 1 to 7.

21. An electron-beam shielding glass, containing: the glass according to any one of the above 1 to 7.

### Advantageous Effects of Invention

Since the glasses according to first and fifth embodiments of the present invention have one side of the main surface and the thickness within the specific ranges, the specific gravity, the Young's modulus, and the thermal expansion coefficient within the specific ranges, and the glass composition within the specific range, warpage of a solar cell can be prevented, and deterioration of mechanical properties and optical properties can be prevented.

Since the glasses according to second to fourth embodiments of the present invention have one side of the main surface and the thickness within the specific ranges, and the glass composition within the specific range, the warpage of a solar cell can be prevented, and the deterioration of mechanical properties and optical properties can be prevented.

### BRIEF DESCRIPTION OF DRAWINGS

FIG. 1 is a diagram showing a correlation between an average thermal expansion coefficient and (absolute value of warpage amount δ/length in warpage direction of glass).

### DESCRIPTION OF EMBODIMENTS

Hereinafter, the present invention will be described in detail based on embodiments, but the present invention is not limited to the following embodiments, and can be freely modified and implemented without departing from the gist of the present invention. In addition, embodiments of the present invention (hereinafter, also abbreviated as the present embodiment) include first to fifth embodiments described below. In the present description, “to” indicating a numerical range is used in the sense of including the numerical values set forth before and after the “to” as a lower limit value and an upper limit value, and unless otherwise specified, “to” is used hereinafter with the same meaning.

In the present description, “being substantially free of” a certain component means that the component is not contained except for inevitable impurities mixed from raw materials and the like. That is, it means that it is not intentionally contained. Note that, in the present description, the content of each component of the glass is represented in terms of mass % based on oxides, unless otherwise specified.

### <Glass>

A glass according to the first embodiment has a specific gravity of 2.2 to 2.7, a Young's modulus of 60 GPa or more, an average thermal expansion coefficient in a range of 50° C. to 200° C. of 2.0 to 6.0 (×10⁻⁶/K), a rectangular shape, a main surface with one side of 50 cm or more and 300 cm or less, a thickness of 0.01 mm or more and 0.5 mm or less, and a total content of Li₂O, Na₂O, and K₂O of 0% to 3.5% in terms of mass % based on oxides, and contains 0.1% to 10% of CeO₂ in terms of mass % based on oxides.

A glass according to the second embodiment contains, in terms of mass % based on oxides: 50% to 80% of SiO₂; 0% to 25% of B₂O₃; 0% to 30% of Al₂O₃; and 0.1% to 10% of CeO₂, and has a total content of Li₂O, Na₂O, and K₂O of 0% to 3.5%, a rectangular shape, a main surface with one side of 50 cm or more and 300 cm or less, and a thickness of 0.01 mm or more and 0.5 mm or less.

A glass according to the third embodiment contains, in terms of mass % based on oxides: 50% to 80% of SiO₂; 0% to 25% of B₂O₃, 0% to 30% of Al₂O₃; and 5% to 10% of TiO₂, and has a total content of Li₂O, Na₂O, and K₂O of 0% to 3.5%, a rectangular shape, a main surface with one side of 50 cm or more and 300 cm or less, and a thickness of 0.01 mm or more and 0.5 mm or less.

A glass according to the fourth embodiment contains, in terms of mass % based on oxides: 50% to 80% of SiO₂; 0% to 25% of B₂O₃; 0% to 30% of Al₂O₃; 0.01% to 10% of TiO₂; and 0.1% to 10% of CeO₂, and has a total content of Li₂O, Na₂O, and K₂O of 0% to 3.5%, a rectangular shape, a main surface with one side of 50 cm or more and 300 cm or less, and a thickness of 0.01 mm or more and 0.5 mm or less.

A glass according to the fifth embodiment has a specific gravity of 2.2 to 2.7, a Young's modulus of 60 GPa or more, an average thermal expansion coefficient in a range of 50° C. to 200° C. of 2.0 to 6.0 (×10⁻⁶/K), a rectangular shape, a main surface with one side of 50 cm or more and 300 cm or less, and a thickness of 0.01 mm or more and 0.5 mm or less, and contains 5% to 10% of TiO₂ in terms of mass % based on oxides.

The glasses according to the first and fifth embodiments have a specific gravity of 2.2 to 2.7. The glasses according to the first and fifth embodiments preferably have a specific gravity of 2.21 or more, 2.22 or more, 2.23 or more, 2.24 or more, 2.25 or more, 2.26 or more, 2.27 or more, 2.28 or more, 2.29 or more, 2.30 or more, 2.31 or more, 2.32 or more, 2.33 or more, 2.34 or more, 2.35 or more, 2.36 or more, 2.37 or more, or 2.38 or more. The glasses according to the first and fifth embodiments preferably have a specific gravity of 2.69 or less, 2.68 or less, 2.67 or less, 2.66 or less, 2.65 or less, 2.64 or less, 2.63 or less, 2.62 or less, 2.61 or less, 2.60 or less, 2.59 or less, 2.58 or less, 2.57 or less, 2.56 or less, 2.55 or less, 2.54 or less, 2.53 or less, 2.52 or less, 2.51 or less, 2.50 or less, 2.49 or less, 2.48 or less, 2.47 or less, or 2.46 or less.

The glasses according to the second to fourth embodiments preferably have a specific gravity of 2.2 to 2.7. The glasses according to the second to fourth embodiments more preferably have a specific gravity of 2.21 or more, 2.22 or more, 2.23 or more, 2.24 or more, 2.25 or more, 2.26 or more, 2.27 or more, 2.28 or more, 2.29 or more, 2.30 or more, 2.31 or more, 2.32 or more, 2.33 or more, 2.34 or more, 2.35 or more, 2.36 or more, 2.37 or more, or 2.38 or more. The glasses according to the second to fourth embodiments more preferably have a specific gravity of 2.69 or less, 2.68 or less, 2.67 or less, 2.66 or less, 2.65 or less, 2.64 or less, 2.63 or less, 2.62 or less, 2.61 or less, 2.60 or less, 2.59 or less, 2.58 or less, 2.57 or less, 2.56 or less, 2.55 or less, 2.54 or less, 2.53 or less, 2.52 or less, 2.51 or less, 2.50 or less, 2.49 or less, 2.48 or less, 2.47 or less, or 2.46 or less.

When the specific gravity is 2.2 or more, an electron beam and a proton beam are effectively shielded, and deterioration of a solar cell can be prevented particularly in the case where the glass is used as a solar cell cover glass. When the specific gravity is 2.7 or less, a reduction in weight can be achieved even in the case where the size is increased.

The specific gravity is measured by using the Archimedes method.

The glasses according to the first and fifth embodiments have a Young's modulus of 60 GPa or more, and preferably 61 GPa or more, 62 GPa or more, 63 GPa or more, 64 GPa or more, 65 GPa or more, 66 GPa or more, 67 GPa or more, 68 GPa or more, 69 GPa or more, 70 GPa or more, 71 GPa or more, or 72 GPa or more.

The glasses according to the second to fourth embodiments preferably have a Young's modulus of 60 GPa or more, and more preferably 61 GPa or more, 62 GPa or more, 63 GPa or more, 64 GPa or more, 65 GPa or more, 66 GPa or more, 67 GPa or more, 68 GPa or more, 69 GPa or more, 70 GPa or more, 71 GPa or more, or 72 GPa or more.

When the Young's modulus is 60 GPa or more, fracture toughness is increased to improve a strength, and the strength required for an increase in size and a reduction in thickness can be ensured.

On the other hand, from the viewpoint of reducing generation of a thermal stress due to a rapid temperature difference, the Young's modulus of the glass according to the present embodiment is preferably 105 GPa or less, more preferably 100 GPa or less, still more preferably 95 GPa or less, and particularly preferably 90 GPa or less.

The Young's modulus is measured by using the ultrasonic pulse method (JIS R1602, 1995).

In the glass according to the present embodiment, a value E/ρ obtained by dividing the Young's modulus E (GPa) by the specific gravity ρ is preferably 27.0 GPa to 37.0 GPa. The value E/ρ is more preferably 27.2 GPa or more, 27.4 GPa or more, 27.6 GPa or more, 27.8 GPa or more, 28.0 GPa or more, 28.2 GPa or more, 28.4 GPa or more, 28.6 GPa or more, 28.8 GPa or more, or 29.0 GPa or more. In addition, the value E/ρ is more preferably 36.8 GPa or less, 36.6 GPa or less, 36.4 GPa or less, 36.2 GPa or less, 36.0 GPa or less, 35.8 GPa or less, 35.6 GPa or less, 35.4 GPa or less, 35.2 GPa or less, or 35.0 GPa or less. When the value E/ρ is 27.0 GPa or more, it is possible to ensure the strength required for the increase in size and the reduction in thickness. When the value E/ρ is 37.0 GPa or less, it is possible to improve the strength required for the increase in size and the reduction in thickness while ensuring a reduction in weight when the size is increased.

With the increase in size and the reduction in thickness of the glass for use in a solar cell, warpage of the solar cell due to a difference in thermal expansion coefficient between silicon and a glass constituting the solar cell becomes a problem. As shown in the FIGURE, an absolute value of a warpage amount δ has a correlation with the average thermal expansion coefficient, and it is thought that the warpage of the solar cell when used in the solar cell can be effectively reduced by defining the range of the average thermal expansion coefficient.

The glasses according to the first and fifth embodiments have an average thermal expansion coefficient in a range of 50° C. to 200° C. of 2.0 to 6.0 (×10⁻⁶/K). In the glasses according to the first and fifth embodiments, the average thermal expansion coefficient in a range of 50° C. to 200° C. is preferably 2.1 (×10⁻⁶/K) or more, 2.2 (×10⁻⁶/K) or more, 2.3 (×10⁻⁶/K) or more, 2.4 (×10⁻⁶/K) or more, 2.5 (×106/K) or more, 2.6 (×10⁻⁶/K) or more, 2.7 (×10⁻⁶/K) or more, 2.8 (×10⁻⁶/K) or more, 2.9 (×106/K) or more, 3.0 (×10⁻⁶/K) or more, 3.1 (×10⁻⁶/K) or more, or 3.2 (×10⁻⁶/K) or more. In the glasses according to the first and fifth embodiments, the average thermal expansion coefficient in a range of 50° C. to 200° C. is preferably 5.9 (×10⁻⁶/K) or less, 5.8 (×10⁻⁶/K) or less, 5.7 (×10⁻⁶/K) or less, 5.6 (×10−⁶/K) or less, 5.5 (×10⁻⁶/K) or less, 5.4 (×10⁻⁶/K) or less, 5.3 (×10⁻⁶/K) or less, 5.2 (×10⁻⁶/K) or less, 5.1 (×10⁻⁶/K) or less, 5.0 (×10⁻⁶/K) or less, 4.9 (×10⁻⁶/K) or less, 4.8 (×10⁻⁶/K) or less, 4.7 (×10⁶/K) or less, 4.6 (×10⁻⁶/K) or less, or 4.5 (×10⁻⁶/K) or less.

The glasses according to the second to fourth embodiments preferably have an average thermal expansion coefficient in a range of 50° C. to 200° C. of 2.0 to 6.0 (×10⁻⁶/K). In the glasses according to the second to fourth embodiments, the average thermal expansion coefficient in a range of 50° C. to 200° C. is more preferably 2.1 (×10⁻⁶/K) or more, 2.2 (×10⁻⁶/K) or more, 2.3 (×10⁻⁶/K) or more, 2.4 (×10⁻⁶/K) or more, 2.5 (×10⁻⁶/K) or more, 2.6 (×10⁻⁶/K) or more, 2.7 (×10⁻⁶/K) or more, 2.8 (×10⁻⁶/K) or more, 2.9 (×10⁻⁶/K) or more, 3.0 (×10⁻⁶/K) or more, 3.1 (×10⁻⁶/K) or more, or 3.2 (×10⁻⁶/K) or more. In the glasses according to the second to fourth embodiments, the average thermal expansion coefficient in a range of 50° C. to 200° C. is preferably 5.9 (×10⁻⁶/K) or less, 5.8 (×10⁻⁶/K) or less, 5.7 (×10⁻⁶/K) or less, 5.6 (×10⁻⁶/K) or less, 5.5 (×10⁻⁶/K) or less, 5.4 (×10⁻⁶/K) or less, 5.3 (×10⁻⁶/K) or less, 5.2 (×10⁻⁶/K) or less, 5.1 (×10⁶/K) or less, 5.0 (×10⁻⁶/K) or less, 4.9 (×10⁻⁶/K) or less, 4.8 (×10⁻⁶/K) or less, 4.7 (×10⁻⁶/K) or less, 4.6 (×10⁻⁶/K) or less, or 4.5 (×10⁻⁶/K) or less.

When the average thermal expansion coefficient in a range of 50° C. to 200° C. is within the above range, the warpage of the solar cell due to a difference in thermal expansion coefficient between silicon and the glass for use in the solar cell can be reduced, particularly in the case of using a solar cell cover glass.

In the present description, the average thermal expansion coefficient is measured using a differential thermal expansion meter according to a method defined in JIS R3102 (1995). A measurement temperature range is 50° C. to 200° C., and the unit is ×10⁻⁶/K.

The glass according to the present embodiment has a rectangular shape, and a main surface with one side of 50 cm or more and 300 cm or less. When the one side of the main surface is 50 cm or more, the labor required for assembling the solar cell is reduced, and a reduction in cost can be realized by the increase in size. In addition, when the one side of the main surface is 300 cm or less, a thin glass can be easily handled without cracks, and the reduction in cost can be achieved. The length of the one side of the main surface is preferably 60 cm or more, 70 cm or more, and 80 cm or more in this order, more preferably 90 cm or more, 100 cm or more, and 110 cm or more in this order, still more preferably 120 cm or more, 130 cm or more, and 140 cm or more in this order, and particularly preferably 150 cm or more. In addition, the length of the one side of the main surface is more preferably 290 cm or less, 280 cm or less, 270 cm or less, 260 cm or less, 250 cm or less, 240 cm or less, 230 cm or less, 220 cm or less, 210 cm or less, or 200 cm or less.

The glass according to the present embodiment has a thickness of 0.01 mm or more and 0.5 mm or less. When the thickness is 0.01 mm or more, the strength can be ensured, and the electron beam and the proton beam can be sufficiently shielded. In addition, when the thickness is 0.5 mm or less, the reduction in weight can be achieved particularly in space applications. The thickness is preferably 0.48 mm or less, 0.46 mm or less, 0.44 mm or less, 0.42 mm or less, 0.40 mm or less, 0.38 mm or less, 0.36 mm or less, 0.34 mm or less, 0.32 mm or less, 0.30 mm or less, 0.28 mm or less, 0.26 mm or less, 0.24 mm or less, 0.22 mm or less, 0.20 mm or less, 0.18 mm or less, 0.16 mm or less, 0.14 mm or less, 0.12 mm or less, or 0.10 mm or less. In addition, the thickness is preferably 0.02 mm or more, 0.03 mm or more, 0.04 mm or more, or 0.05 mm or more.

In the glass according to the present embodiment, an average absorbance change amount in a wavelength range of 400 nm to 800 nm in terms of a thickness of 100 μm during electron beam irradiation is preferably 0.01 or less, and more preferably 0.009 or less, 0.008 or less, 0.007 or less, 0.006 or less, or 0.005 or less. When the average absorbance change amount in terms of a thickness of 100 μm is 0.01 or less, coloration due to the electron beam is prevented, and sufficient optical properties can be ensured in space applications. The lower limit of the average absorbance change amount in terms of a thickness of 100 μm is not particularly limited, and is, for example, 0.0001 or more.

In the present description, the value “in terms of a thickness of 100 μm” refers to a value obtained by converting the absorbance change amount into a value when the thickness of the glass is 100 μm.

The average absorbance change amount in the wavelength range of 400 nm to 800 nm in terms of a thickness of 100 μm during electron beam irradiation is determined by the following procedure.
(a1) As the electron beam irradiation, a glass substrate to be irradiated is left to stand horizontally on a table, and the glass substrate is irradiated with an electron beam of 1×10¹⁵ electrons/cm² at an energy amount of 1 MeV using an electron beam irradiation apparatus (for example, model number: EPS-3000 kV manufactured by NHV Corporation).
(a2) A transmittance is measured for each glass substrate after the electron beam irradiation. The measurement is performed within one week after the electron beam irradiation. The absorbance before and after electron beam irradiation is calculated based on the measured transmittance and converted into the absorbance at a thickness of 100 μm.
(a3) The average absorbance change amount in the wavelength range of 400 nm to 800 nm is calculated according to the following equation.

$$\frac{{\sum }_{λ = 400}^{800} ( {A}_{after} [ λ ] - {A}_{before} [ λ ] )}{400} \qquad [ Math . 1 ]$$

A [λ]: absorbance at wavelength λ
A_{after}[λ]: absorbance at wavelength λ after electron beam irradiation
A_{before}[λ]: absorbance at wavelength λ before electron beam irradiation

In the glass according to the present embodiment, a value obtained by subtracting a light transmittance at a wavelength of 300 nm from a light transmittance at a wavelength of 400 nm at a thickness of 100 μm is preferably 50% or more, and more preferably 55% or more, 60% or more, 65% or more, 70% or more, 75% or more, or 80% or more. When the value is 50% or more, deterioration of properties of the solar cell due to the electron beam can be effectively prevented particularly in space applications. The upper limit of the value is not particularly limited, and is, for example, 95% or less.

The transmittance can be measured using a spectrophotometer (for example, U-4100 manufactured by Hitachi High-Tech Corporation).

The glass according to the present embodiment preferably has a transmittance of 80% to 93% at a wavelength of 400 nm at a thickness of 100 sm. The transmittance is more preferably 81% or more, still more preferably 82% or more, particularly more preferably 83% or more, even preferably 84% or more, even still more preferably 85% or more, and particularly preferably 86% or more. When the transmittance at a wavelength of 400 nm at a thickness of 100 μm is 80% or more, power generation properties of the solar cell can be further improved in the case where the glass is used as a solar cell cover glass.

In the present description, the transmittance at a thickness of 100 μm refers to the transmittance measured at a thickness of 100 μm.

The glass according to the present embodiment preferably has a transmittance of 0% to 10% at a wavelength of 300 nm at a thickness of 100 μm. The transmittance is more preferably 0.5% or more, still more preferably 1% or more, particularly more preferably 1.5% or more, even preferably 2% or more, even still more preferably 2.5% or more, and particularly preferably 3% or more. When the transmittance at a wavelength of 300 nm at a thickness of 100 μm is 0% or more, the power generation properties of the solar cell can be further improved in the case where the glass is used as a solar cell cover glass. When the transmittance at a wavelength of 300 nm at a thickness of 100 μm is 10% or less, deterioration of the solar cell due to ultraviolet rays can be prevented.

In the glass according to the present embodiment, a wavelength exhibiting a transmittance of 50% at a thickness of 100 μm is preferably 300 nm to 370 nm. The wavelength is more preferably 310 nm or more, still more preferably 320 nm or more, and particularly preferably 330 nm or more. In addition, the wavelength is more preferably 360 nm or less, still more preferably 355 nm or less, and particularly more preferably 350 nm or less. When the wavelength is 300 nm or more, the deterioration of the solar cell due to ultraviolet rays can be prevented. When the wavelength is 370 nm or less, the power generation properties of the solar cell can be further improved in the case where the glass is used as a solar cell cover glass.

The glass according to the present embodiment preferably has a transmittance of 80% to 94% at a wavelength of 400 nm at a thickness of 50 μm. The transmittance is more preferably 81% or more, still more preferably 82% or more, particularly more preferably 83% or more, even preferably 84% or more, even still more preferably 85% or more, and particularly preferably 86% or more. In addition, the transmittance is preferably 94% or less, more preferably 93% or less, still more preferably 92% or less, particularly preferably 91% or less, and most preferably 90% or less. When the transmittance at a wavelength of 400 nm at a thickness of 50 μm is 80% or more, the power generation properties of the solar cell can be further improved in the case where the glass is used as a solar cell cover glass.

In the present description, the transmittance at a thickness of 50 μm refers to the transmittance measured at a thickness of 50 μm.

The glass according to the present embodiment preferably has a transmittance of 0% to 25% at a wavelength of 300 nm at a thickness of 50 μm. The transmittance is more preferably 1% or more, still more preferably 2% or more, particularly more preferably 3% or more, even preferably 4% or more, even still more preferably 5% or more, and particularly preferably 7% or more. In addition, the transmittance is more preferably 23% or less, still more preferably 20% or less, particularly preferably 15% or less, and most preferably 10% or less. When the transmittance at a wavelength of 300 nm at 50 μm is 0% or more, the power generation properties of the solar cell can be further improved in the case where the glass is used as a solar cell cover glass. When the transmittance at a wavelength of 300 nm at 50 μm is 25% or less, the deterioration of the solar cell due to ultraviolet rays can be prevented.

In the glass according to the present embodiment, a wavelength exhibiting a transmittance of 50% at a thickness of 50 μm is preferably 250 nm to 360 nm. The wavelength is more preferably 260 nm or more, still more preferably 270 nm or more, particularly preferably 280 nm or more, even more preferably 290 nm or more, and even still more preferably 300 nm or more. In addition, the wavelength is more preferably 350 nm or less, still more preferably 340 nm or less, even more preferably 330 nm or less, particularly preferably 320 nm or less, and most preferably 310 nm or less. When the wavelength is 250 nm or more, the deterioration of the solar cell due to ultraviolet rays can be prevented. When the wavelength is 360 nm or less, sufficient optical properties can be ensured even in the case where the size is increased.

In the glass according to the present embodiment, a fracture toughness value K_{IC} is preferably 0.78 MPa·m^{1/2} or more, more preferably 0.80 MPa·m^{1/2} or more, still more preferably 0.81 MPa·m^{1/2} or more, and particularly preferably 0.82 MPa·m^{1/2} or more. When K_{IC} is 0.78 MPa·m^{1/2} or more, a sufficient strength can be ensured even in the case where the size is increased. The upper limit of the fracture toughness value K_{IC} is not particularly limited, and may be, for example, 1.00 MPa·m^{1/2} or less.

In the present description, the fracture toughness value K_{IC} refers to a value measured by using a double cleavage drilled compression (DCDC) method (Acta metall. mater. Vol. 43, pp. 3453-3458, 1995) or an SEPB method specified in JIS R1607 (2015). Since the DCDC method can determine the fracture toughness value K_{IC} more accurately than the SEPB method, the fracture toughness value K_{IC} is more preferably a value determined by using the DCDC method.

In the glass according to the present embodiment, a β-OH is preferably 1.0 mm⁻¹ or less, more preferably 0.5 mm⁻¹ or less, still more preferably 0.4 mm⁻¹ or less, and particularly preferably 0.3 mm⁻¹ or less. When the β-OH is 1.0 mm⁻¹ or less, an amount of platinum eluted into the glass from a platinum crucible, a platinum stirrer, or other production facilities using platinum can be increased, and an ultraviolet ray absorption effect can be enhanced. The lower limit of the β-OH is not particularly limited, and is, for example, 0.01 mm⁻¹ or more.

The β-OH of the glass is determined by measuring the transmittance of the glass using FT-IR and using the following equations.

$$β - OH = ( \frac{1}{X} ) {log}_{10} ( \frac{{T}_{ref}}{{T}_{OH}} ) \qquad [ Math . 2 ]$$

X: thickness (mm) of glass
T_{ref}: transmittance (%) at reference wavelength of 3846 cm⁻¹
T_{OH}: minimum transmittance (%) in the vicinity of hydroxy group absorption wavelength of 3600 cm⁻¹

In the glass according to the present embodiment, an “absolute value of warpage amount δ/length in warpage direction of glass”, which is a value obtained by dividing the absolute value of the calculated warpage amount δ by the length (mm) in a warpage direction of the glass based on Bi-Metal warpage calculation as defined by the following equation, is preferably, for example, the following (b1) to (b4).
(b1) In the case where the length in the warpage direction of the glass is 1,000 mm and the thickness of the glass is 0.1 mm, the (absolute value of warpage amount δ/length in warpage direction of glass) is preferably 0.30 or less, more preferably 0.20 or less, still more preferably 0.15 or less, particularly preferably 0.10 or less, and most preferably 0.05 or less. The (absolute value of warpage amount δ/length in warpage direction of glass) is preferably as small as possible, the lower limit thereof is not particularly limited, and is, for example, 0.001 or more.
(b2) In the case where the length in the warpage direction of the glass is 1,000 mm and the thickness of the glass is 0.05 mm, the (absolute value of warpage amount S/length in warpage direction of glass) is preferably 0.20 or less, more preferably 0.15 or less, still more preferably 0.10 or less, and particularly preferably 0.05 or less. The (absolute value of warpage amount δ/length in warpage direction of glass) is preferably as small as possible, the lower limit thereof is not particularly limited, and is, for example, 0.001 or more.
(b3) In the case where the length in the warpage direction of the glass is 500 mm and the thickness of the glass is 0.1 mm, the (absolute value of warpage amount δ/length in warpage direction of glass) is preferably 0.20 or less, more preferably 0.15 or less, still more preferably 0.10 or less, and particularly preferably 0.05 or less. The (absolute value of warpage amount S/length in warpage direction of glass) is preferably as small as possible, the lower limit thereof is not particularly limited, and is, for example, 0.001 or more.
(b4) In the case where the length in the warpage direction of the glass is 500 mm and the thickness of the glass is 0.05 mm, the (absolute value of warpage amount δ/length in warpage direction of glass) is preferably 0.20 or less, more preferably 0.15 or less, still more preferably 0.10 or less, and particularly preferably 0.05 or less. The (absolute value of warpage amount δ/length in warpage direction of glass) is preferably as small as possible, the lower limit thereof is not particularly limited, and is, for example, 0.001 or more.

When the (absolute value of warpage amount δ/length in warpage direction of glass) is equal to or less than the upper limit for the (b1) to (b4), the function of the solar cell can be ensured even in the case where the solar cell glass is reduced in thickness and increased in size.

$$δ = \frac{6 {L}^{2} ( {α}_{2} - {α}_{1} ) ( {T}_{min} - {T}_{max} ) {( 1 + m )}^{2}}{8 h [ 3 {( 1 + m )}^{2} + ( 1 + mn ) \{ {m}^{2} + {( mn )}^{- 1} \} ]} \qquad [ Math . 3 ]$$

L: length [mm] in warpage direction of glass
α₁: thermal expansion coefficient [ppm/K] of solar cell
α₂: thermal expansion coefficient [ppm/K] of glass
E₁: Young's modulus [GPa] of solar cell
E₂: Young's modulus [GPa] of glass
Tₘₐₓ: assumed maximum temperature (° C.)
Tₘᵢₙ: assumed minimum temperature (° C.)
a₁: thickness [mm] of solar cell
a₂: thickness [mm] of glass
h: a₁+a₂ [mm]
m: a₁/a₂
n: E₁/E₂
δ: warpage amount [mm]

It is assumed that single crystal silicon is used for the solar cell with reference to “MAXEON™ GENIII SOLAR CELLS” manufactured by Sunpower. The thermal expansion coefficient and the Young's modulus of the solar cell are α₁=3.2 ppm/° C. and E₁=190 GPa, respectively, assuming that single crystal silicon is used. As the thermal expansion coefficient of the glass, a value of the average thermal expansion coefficient (ppm/° C.) in a range of 50° C. to 200° C. is used. The thickness of the solar cell is assumed to be 0.15 mm.

The glass according to the present embodiment has a temperature (T₂) at which a viscosity log η is 2 (poise) of preferably 1,800° C. or lower, more preferably 1,750° C. or lower, and still more preferably 1,700° C. or lower, from the viewpoint of reducing the viscosity and improving productivity, and from the viewpoint of SDGs. The T₂ is generally 1,400° C. or higher.

The glass according to the present embodiment has a temperature (T₄) at which the viscosity log η is 4 (poise) of preferably 1,550° C. or lower, more preferably 1,500° C. or lower, still more preferably 1,450° C. or lower, 1,400° C. or lower, and 1,350° C. or lower in this order, and most preferably 1,300° C. or lower, from the viewpoint of reducing the viscosity and improving the productivity, and from the viewpoint of the SDGs. The T₄ is generally 800° C. or higher.

The glass according to the present embodiment has an average value of flatness (Ra) within 1 μm×1 μm of preferably 2.0 nm or less, more preferably 1.5 nm or less, still more preferably 1.0 nm or less, and even more preferably 0.8 nm or less, the flatness (Ra) within 1 μm×1 μm being obtained by cutting five glasses each of 50 mm×50 mm from a glass having one side of 50 cm or more at a center and at positions close to four corners and performing measurement by using AFM. When the flatness is 2.0 nm or less, it is possible to obtain a strength that makes it less likely to crack during handling. The lower limit value of the average value of the flatness is preferably 0.2 nm or more, more preferably 0.3 nm or more, still more preferably 0.4 nm or more, and even more preferably 0.5 nm or more, since a certain degree of roughness helps reduce static electricity from interleaving paper between the glass and the glass during handling.

### <<Composition>>

In the first to fourth embodiments, R₂O (the total content of Li₂O, Na₂O, and K₂O) is 0% to 3.5%. In the first to fourth embodiments, R₂O is preferably 3.4% or less, 3.3% or less, 3.2% or less, 3.1% or less, 3.0% or less, 2.9% or less, 2.8% or less, 2.7% or less, 2.6% or less, 2.5% or less, 2.4% or less, 2.3% or less, 2.2% or less, 2.1% or less, 2.0% or less, 1.9% or less, 1.8% or less, 1.7% or less, 1.6% or less, 1.5% or less, 1.4% or less, 1.3% or less, 1.2% or less, 1.1% or less, 1.0% or less, 0.9% or less, 0.8% or less, 0.7% or less, 0.6% or less, 0.5% or less, 0.4% or less, 0.3% or less, 0.2% or less, or 0.1% or less.

In the fifth embodiment, R₂O is preferably 0% to 3.5%. In the fifth embodiment, R₂O is more preferably 3.4% or less, 3.3% or less, 3.2% or less, 3.1% or less, 3.0% or less, 2.9% or less, 2.8% or less, 2.7% or less, 2.6% or less, 2.5% or less, 2.4% or less, 2.3% or less, 2.2% or less, 2.1% or less, 2.0% or less, 1.9% or less, 1.8% or less, 1.7% or less, 1.6% or less, 1.5% or less, 1.4% or less, 1.3% or less, 1.2% or less, 1.1% or less, 1.0% or less, 0.9% or less, 0.8% or less, 0.7% or less, 0.6% or less, 0.5% or less, 0.4% or less, 0.3% or less, 0.2% or less, or 0.1% or less.

By setting R₂O to 3.5% or less, the difference in thermal expansion coefficient between silicon and the glass for use in the solar cell can be reduced, and the warpage of the solar cell can be effectively reduced even in the case where the size is increased. R₂O is preferably as small as possible, and is, for example, 0.01% or more from the viewpoint of manufacturability.

Li₂O is an optional component that improves the Young's modulus and the fracture toughness value of the glass and that improves mechanical properties of the glass. In the present embodiment, in the case where Li₂O is contained, the content thereof is preferably 0.01% or more, more preferably 0.02% or more, still more preferably 0.03% or more, particularly preferably 0.04% or more, and most preferably 0.1% or more. In addition, the content of Li₂O is preferably 2.0% or less, more preferably 1.5% or less, still more preferably 1.0% or less, and particularly preferably 0.5% or less, from the viewpoint of reducing the difference in thermal expansion coefficient between silicon and the glass and effectively reducing the warpage of the solar cell even in the case where the size is increased.

Na₂O is an optional component that improves meltability of the glass, and may be contained. In the present embodiment, in the case where Na₂O is contained, the content thereof is preferably 0.01% or more, more preferably 0.02% or more, still more preferably 0.05% or more, particularly preferably 0.5% or more, and most preferably 1.0% or more. In addition, the content of Na₂O is preferably 2.0% or less, more preferably 1.5% or less, still more preferably 1.2% or less, and particularly preferably 1.1% or less, from the viewpoint of reducing the difference in thermal expansion coefficient between silicon and the glass and effectively reducing the warpage of the solar cell even in the case where the size is increased.

K₂O is an optional component that improves the meltability of the glass, and may be contained. In the present embodiment, in the case where K₂O is contained, the content thereof is preferably 0.01% or more, more preferably 0.02% or more, still more preferably 0.03% or more, and particularly preferably 0.05% or more. In addition, the content of K₂O is preferably 3.0% or less, more preferably 2.0% or less, still more preferably 1.5% or less, particularly preferably 1.0% or less, and most preferably 0.5% or less, from the viewpoint of reducing the difference in thermal expansion coefficient between silicon and the glass and effectively reducing the warpage of the solar cell even in the case where the size is increased.

With the ultraviolet ray, the electron beam, a proton beam, and a cosmic ray (for example, a γ-ray and an α-ray), the glass tends to deteriorate, and transmission properties thereof tend to decrease. Therefore, examples of properties required for the glass for use as a solar cell cover glass in space applications include properties of transmitting a spectral sensitivity wavelength region of the solar cell, shielding the ultraviolet ray, the electron beam, the proton beam, and the cosmic ray, and not decreasing the transmission properties due to them.

CeO₂ is a component that improves an ultraviolet ray shielding effect and that prevents the coloration due to the electron beam.

In the first, second, and fourth embodiments, the content of CeO₂ is 0.1% to 10% from the viewpoint of preventing the coloration of the glass due to the electron beam and sufficiently ensuring the ultraviolet ray shielding effect. In the first, second, and fourth embodiments, the content of CeO₂ is more preferably 0.2% or more, 0.4% or more, and 0.6% or more in this order, still more preferably 0.8% or more, 1.0% or more, and 1.2% or more in this order, and particularly preferably 1.4% or more, 1.6% or more, and 1.8% or more in this order. In addition, in the first, second, and fourth embodiments, the content of CeO₂ is preferably 10% or less, more preferably 7% or less, still more preferably 6% or less, particularly preferably 5% or less, and most preferably 3% or less, from the viewpoint of preventing devitrification.

In the third and fifth embodiments, the content of CeO₂ is preferably 0.1% to 10% from the viewpoint of preventing the coloration of the glass due to the electron beam and sufficiently ensuring the ultraviolet ray shielding effect. In the third and fifth embodiments, the content of CeO₂ is more preferably 0.2% or more, 0.4% or more, and 0.6% or more in this order, still more preferably 0.8% or more, 1.0% or more, and 1.2% or more in this order, and particularly preferably 1.4% or more, 1.6% or more, and 1.8% or more in this order. In addition, in the third and fifth embodiments, the content of CeO₂ is preferably 10% or less, more preferably 7% or less, still more preferably 6% or less, particularly preferably 5% or less, and most preferably 3% or less, from the viewpoint of preventing devitrification.

In the present embodiment, when the thickness is t (mm) and the content of CeO₂ in the glass composition is a (mass %), a/t is preferably 0.2 mass %/mm to 200 mass %/mm from the viewpoint of improving the ultraviolet ray shielding effect. The α/t is more preferably 5 mass %/mm or more, still more preferably 10 mass %/mm or more, and particularly preferably 15 mass %/mm or more. In addition, in the present embodiment, the α/t is more preferably 160 mass %/mm or less, still more preferably 120 mass %/mm or less, and particularly preferably 80 mass %/mm or less.

TiO₂ is a component that prevents solarization by UVC.

In the first and second embodiments, the content of TiO₂ is preferably 0.01% to 10%. In the first and second embodiments, the content of TiO₂ is preferably 0.30% or more, 0.50% or more, and 0.70% or more in this order, more preferably 1.0% or more, 1.2% or more, and 1.4% or more in this order, and still more preferably 1.5% or more, 2.0% or more, 3.0% or more, 4.0% or more, and 5.0% or more in this order, from the viewpoint of further preventing the solarization by UVC. In addition, in the first and second embodiments, the content of TiO₂ is more preferably 7% or less, still more preferably 6% or less, and particularly preferably 5% or less, from the viewpoint of further preventing the solarization by UVC and preventing the coloration of the glass.

In the third and fifth embodiments, the content of TiO₂ is 5% to 10%. In the third and fifth embodiments, the content of TiO₂ is preferably 5.5% or more, more preferably 6.0% or more, and still more preferably 7% or more, from the viewpoint of further preventing the solarization by UVC. In addition, in the third and fifth embodiments, the content of TiO₂ is preferably 9.0% or less, more preferably 8.5% or less, still more preferably 8.0% or less, and particularly preferably 7.5% or less, from the viewpoint of further preventing the solarization by UVC and preventing the coloration of the glass.

In the fourth embodiment, the content of TiO₂ is 0.01% to 10%. In the fourth embodiment, the content of TiO₂ is preferably 0.30% or more, 0.50% or more, and 0.70% or more in this order, more preferably 1.0% or more, 1.2% or more, and 1.4% or more in this order, and still more preferably 1.5% or more, 2.0% or more, and 3.0% or more in this order, from the viewpoint of further preventing the solarization by UVC. In addition, in the fourth embodiment, the content of TiO₂ is more preferably 7.0% or less, still more preferably 6.0% or less, and particularly preferably 5.0% or less, from the viewpoint of further preventing the solarization by UVC and preventing the coloration of the glass.

In the first, second, and fourth embodiments, when the thickness is t (mm) and the content of TiO₂ in the glass composition is β (mass %), β/t is preferably 0.005 mass %/mm to 200 mass %/mm from the viewpoint of preventing the solarization by UVC. In the first, second, and fourth embodiments, the/t is more preferably 1 mass %/mm or more, still more preferably 5 mass %/mm or more, and particularly preferably 10 mass %/mm or more. In addition, in the first, second, and fourth embodiments, the β/t is more preferably 160 mass %/mm or less, still more preferably 120 mass %/mm or less, and particularly preferably 80 mass %/mm or less. In the third and fifth embodiments, when the thickness is t (mm) and the content of TiO₂ in the glass composition is β (mass %), β/t is preferably 10 mass %/mm to 200 mass %/mm from the viewpoint of preventing the solarization by UVC. In the third and fifth embodiments, the β/t is more preferably 50 mass %/mm or more, still more preferably 100 mass %/mm or more, and particularly preferably 150 mass %/mm or more. In addition, in the third and fifth embodiments, the β/t is more preferably 190 mass %/mm or less, still more preferably 180 mass %/mm or less, and particularly preferably 170 mass %/mm or less.

In the glass according to the present embodiment, a value of X represented by the following equation is preferably 0.5 or more and 50 or less from the viewpoint of further enhancing the ultraviolet ray shielding effect and setting the wavelength at which the transmittance is 50% in an ultraviolet region to a longer wavelength side. The value of X is more preferably 40 or less, still more preferably 35 or less, and particularly preferably 30 or less. The value of X is more preferably 1 or more, still more preferably 3 or more, and particularly preferably 5 or more.

$$X = 5 \times [ {CeO}_{2} ] + [ {TiO}_{2} ] \qquad ( Equation )$$

In the equation, the parenthesis [ ] represents the content in terms of mass % based on oxides.

SiO₂ is a component that constitutes a glass framework, and is essential.

In the first and fifth embodiments, the content of SiO₂ is preferably 50% to 80%. In the first and fifth embodiments, the content of SiO₂ is more preferably 51% or more, still more preferably 52% or more, particularly preferably 53% or more, and most preferably 55% or more. In addition, in the first and fifth embodiments, the content of SiO₂ is more preferably 75% or less, still more preferably 70% or less, particularly preferably 65% or less, and most preferably 60% or less. When the content of SiO₂ is 50% or more, chemical durability can be improved. When the content of SiO₂ is 80% or less, an increase in T₂ or T₄ can be prevented, and the meltability or moldability of the glass can be improved.

In the second to fourth embodiments, the content of SiO₂ is 50% to 80%. In the second to fourth embodiments, the content of SiO₂ is preferably 51% or more, more preferably 52% or more, still more preferably 53% or more, and particularly preferably 55% or more. In addition, in the second to fourth embodiments, the content of SiO₂ is preferably 75% or less, more preferably 70% or less, still more preferably 65% or less, and particularly preferably 60% or less. When the content of SiO₂ is 50% or more, the chemical durability can be improved. When the content of SiO₂ is 80% or less, an increase in T₂ or T₄ can be prevented, and the meltability or the moldability of the glass can be improved.

B₂O₃ may be contained in order to improve the meltability at a high temperature or the glass strength. On the other hand, when the content of B₂O₃ is large, the Young's modulus decreases, the fracture toughness decreases, and the strength tends to decrease. In addition, the glass is likely to undergo phase separation and lose transparency, making it difficult to obtain a homogeneous glass, and the moldability of the glass may decrease.

In the first and fifth embodiments, in the case where B₂O₃ is contained, the content thereof is preferably 25% or less, more preferably 20% or less, still more preferably 18% or less, particularly preferably 17% or less, 16% or less, 15% or less, 14% or less, 13% or less, and 12% or less in this order, and most preferably 10% or less.

In the second to fourth embodiments, the content of B₂O₃ is 0% to 25%. In the second to fourth embodiments, the content of B₂O₃ is preferably 20% or less, more preferably 17% or less, still more preferably 15% or less, particularly preferably 14% or less, 13% or less, 12% or less, 11% or less, 10% or less, and 9% or less in this order, and most preferably 8% or less. In the present embodiment, the content of B₂O₃ is, for example, preferably 0.5% or more, more preferably 1% or more, still more preferably 2% or more, particularly preferably 3% or more, and most preferably 4% or more, from the viewpoint of improving the meltability at a high temperature or the glass strength.

Al₂O₃ is a component that improves mechanical properties such as the Young's modulus and the fracture toughness value of the glass and that improves weather resistance of the glass. On the other hand, in the case of being added together with CeO₂, Al₂O₃ is also a component that deteriorates devitrification resistance.

In the first and fifth embodiments, the content of Al₂O₃ is preferably 0% to 30%.

In the second to fourth embodiments, the content of Al₂O₃ is 0% to 30%.

When Al₂O₃ is 30% or less, an increase in T₂ or T₄ can be prevented, and the meltability or the moldability of the glass can be improved.

In the first to fifth embodiments, in the case where Al₂O₃ is contained, it is preferably 1% or more, more preferably 2% or more, still more preferably 4% or more, and particularly preferably 5% or more, 5.5% or more, 6% or more, 6.5% or more, 7% or more, 7.5% or more, 8% or more, and 9% or more in this order.

In the first and fifth embodiments, the content of Al₂O₃ is more preferably 25% or less, and still more preferably 20% or less. When Al₂O₃ is 30% or less, an increase in T₂ or T₄ can be prevented, and the meltability or the moldability of the glass can be improved.

In the second to fourth embodiments, the content of Al₂O₃ is preferably 25% or less, more preferably 23% or less, and still more preferably 20% or less.

As₂O₃ is a component that promotes the solarization and is an optional component. In the present embodiment, the content of As₂O₃ is preferably 0.25% or less, more preferably 0.10% or less, and still more preferably 0.05% or less, from the viewpoint of preventing the solarization and from the viewpoint of the SDGs. The lower limit of the content of As₂O₃ is not particularly limited, and in the case where it is contained, it is preferably 0.001% or more from the viewpoint of a refining property.

Sb₂O₃ is a component that functions as a refining agent. In the present embodiment, the content of Sb₂O₃ is preferably 0.25% or less, more preferably 0.2% or less, and still more preferably 0.1% or less, from the viewpoint of the SDGs. The lower limit of the content of Sb₂O₃ is not particularly limited, and in the case where it is contained, it is preferably 0.001% or more from the viewpoint of the refining property.

In the present embodiment, the total content of As₂O₃ and Sb₂O₃ is preferably 0% or more and less than 0.25%, more preferably 0% or more and 0.2% or less, still more preferably 0% or more and 0.1% or less, and particularly preferably 0% or more and 0.05% or less, from the viewpoint of the SDGs.

SnO₂ is a component that prevents the solarization. In the present embodiment, the content of SnO₂ is preferably 0.01% or more and 0.4% or less. In the present embodiment, the content of SnO₂ is more preferably 0.02% or more, still more preferably 0.05% or more, and particularly preferably 0.1% or more, from the viewpoint of further preventing the solarization. In addition, the content of SnO₂ is more preferably 0.3% or less, and still more preferably 0.2% or less, from the viewpoint of preventing a decrease in devitrification resistance.

Fe₂O₃ is an optional component, but may be contained from the viewpoint of improving the ultraviolet ray shielding effect and preventing the coloration due to the electron beam. On the other hand, it is also a component that decreases the transmittance from a visible region to a near-infrared region and that decreases cell efficiency. In the present embodiment, the content of Fe₂O₃ is preferably 3% or less, and more preferably 2% or less, 1.5% or less, 1% or less, 0.8% or less, 0.6% or less, 0.4% or less, 0.2% or less, 0.1% or less, 0.09% or less, 0.08% or less, 0.07% or less, 0.06% or less, 0.05% or less, 0.04% or less, 0.03% or less, 0.02% or less, or 0.01% or less. In addition, the content thereof is not particularly limited in lower limit, and is preferably 0.001% or more, and more preferably 0.002% or more, 0.003% or more, or 0.004% or more in the case where it is contained, from the viewpoint of the ultraviolet ray shielding effect and preventing the coloration due to the electron beam. When the content of Fe₂O₃ is 0.001% or more, the ultraviolet ray shielding effect can be ensured, and the coloration due to the electron beam can be further prevented. When the content of Fe₂O₃ is 3% or less, a visible light transmittance can be increased.

In the case where the glass according to the present embodiment contains CeO₂, a value of Y represented by the following equation is preferably 0 or more and 1,300 or less from the viewpoint of further enhancing the ultraviolet ray shielding effect and controlling a redox state of Ce. The value of Y is more preferably 1,200 or less, still more preferably 1,000 or less, and particularly preferably 800 or less. The value of Y is more preferably 100 or more, still more preferably 300 or more, and particularly preferably 500 or more.

$$Y = [ {CeO}_{2} ] / [ {Fe}_{2} {O}_{3} ] \qquad ( Equation )$$

In the equation, the parenthesis [ ] represents the content in terms of mass % based on oxides.

MgO is an optional component that prevents a decrease in strength or that improves the meltability. In the present embodiment, in the case where MgO is contained, the content thereof is preferably 0.5% or more, more preferably 1.0% or more, still more preferably 1.5% or more, and particularly preferably 2.0% or more. In the present embodiment, the content of MgO is preferably 13% or less, more preferably 12.5% or less, still more preferably 12% or less, and particularly preferably 11.5% or less, 11% or less, 10.5% or less, 10% or less, 9.5% or less, 9% or less, 8.5% or less, 8% or less, 7.5% or less, and 7% or less in this order.

BaO is a component that improves the meltability at a high temperature or that makes the devitrification less likely to occur, and may be contained. In the present embodiment, the content of BaO is preferably 0% or more and 6.5% or less. In the case where BaO is contained, the content thereof is more preferably 0.5% or more, still more preferably 1.0% or more, and particularly preferably 1.5% or more. The content of BaO is more preferably 5.0% or less, still more preferably 4.0% or less, and particularly preferably 3.0% or less, from the viewpoint of preventing an increase in specific gravity.

CaO may be contained to improve the meltability at a high temperature or make the devitrification less likely to occur. In the present embodiment, in the case where CaO is contained, the content thereof is preferably 0.5% or more, more preferably 1.0% or more, still more preferably 1.5% or more, and particularly preferably 2.0% or more. In the present embodiment, the content of CaO is preferably 13% or less, more preferably 12.5% or less, still more preferably 12% or less, and particularly preferably 11.5% or less, 11% or less, 10.5% or less, 10% or less, 9.5% or less, 9% or less, 8.5% or less, 8% or less, 7.5% or less, and 7% or less in this order.

SrO may be contained to improve the meltability at a high temperature or make the devitrification less likely to occur. In the present embodiment, in the case where SrO is contained, the content thereof is more preferably 0.5% or more, still more preferably 1.0% or more, and particularly preferably 1.5% or more. The content of SrO is preferably 8% or less, more preferably 6% or less, still more preferably 4% or less, particularly preferably 2% or less, and most preferably 0.1% or less, from the viewpoint of preventing an increase in specific gravity.

In the present embodiment, in the case where at least one selected from the group consisting of BaO, CaO, and SrO is contained, a total content of these three components is preferably 10% or less, and more preferably 8% or less, 6% or less, 4% or less, or 2% or less.

From the viewpoint of increasing the transmittance at a wavelength of 300 nm to 1100 nm and improving the cell efficiency of the solar cell, it is preferable that the glass is substantially free of NiO. In the present embodiment, in the case where NiO is contained, the content thereof is preferably 1% or less, more preferably 0.5% or less, still more preferably 0.1% or less, and even more preferably 0.08% or less.

ZrO₂ is not an essential component, but may be contained in a range of 1.6% or less in order to decrease the viscosity at a high temperature or improve the chemical durability, among other reasons. In the present embodiment, when the content of ZrO₂ is 1.6% or less, a decrease in strength can be prevented. The content of ZrO₂ is more preferably 1.5% or less, still more preferably 1.4% or less, particularly preferably 1.3% or less, and most preferably 1.1% or less.

ZnO may be contained in order to improve the meltability of the glass at a high temperature, and in this case, the content thereof is preferably 1% or less, more preferably 0.5% or less, and still more preferably 0.25% or less. In the case of producing the glass by using a float method, the content of ZnO is preferably 0.5% or less, more preferably 0.25% or less, and the glass is still more preferably substantially free of ZnO, and the content of ZnO is most preferably 0%. When the content of ZnO is 1% or less, reduction during float molding can be prevented, and generation of product defects can be prevented.

V₂O₅ may be contained in order to improve the ultraviolet ray shielding effect. In the case where V₂O₅ is contained, the content thereof is preferably 0.01% or more, more preferably 0.05% or more, still more preferably 0.1% or more, and particularly preferably 0.2% or more, from the viewpoint of further improving the ultraviolet ray shielding effect. On the other hand, in the case where V₂O₅ is contained, the content thereof is preferably 1.0% or less, more preferably 0.8% or less, still more preferably 0.6% or less, and particularly preferably 0.4% or less, from the viewpoint of preventing the coloration.

SO₃, a chloride, and a fluoride may be appropriately contained as a refining agent during melting of the glass. However, in order to improve the cell efficiency of the solar cell in the case of using the glass as a solar cell cover glass, it is preferable to reduce the amount of components such as Cr₂O₃ having absorption in a wavelength region of 300 nm to 1,100 nm mixed as impurities in the raw material as much as possible, and in the case of containing the component, it is preferably 0.15% or less, more preferably 0.1% or less, and particularly preferably 0.05% or less.

Examples of one aspect of the glass according to the first embodiment include the following aspects (1a) to (1c).
(1a) An aspect in which the total content of Li₂O, Na₂O, and K₂O is 0% to 3.5%, and CeO₂ is contained in an amount of 0.1% to 10%, in terms of mass % based on oxides.
(1b) An aspect in which the total content of Li₂O, Na₂O, and K₂O is 0% to 3.5%, CeO₂ is contained in an amount of 0.1% to 10%, and TiO₂ is contained in an amount of 5% to 10%, in terms of mass % based on oxides.
(1c) An aspect in which the total content of Li₂O, Na₂O, and K₂O is 0% to 3.5%, CeO₂ is contained in an amount of 0.1% to 10%, and TiO₂ is contained in an amount of 0.01% to 10%, in terms of mass % based on oxides.

Specific examples of the composition of the glass according to the present embodiment include the following.
(1) A glass containing 50% to 80% of SiO₂, 0% to 25% of B₂O₃, 0% to 30% of Al₂O₃, 0.1% to 10% of CeO₂, and 0% to 3.5% of R₂O in terms of mass % based on oxides.
(2) A glass containing 50% to 80% of SiO₂, 0% to 25% of B₂O₃, 0% to 30% of Al₂O₃, 5% to 10% of TiO₂, and 0% to 3.5% of R₂O in terms of mass % based on oxides.
(3) A glass containing 50% to 80% of SiO₂, 0% to 25% of B₂O₃, 0% to 30% of Al₂O₃, 0.01% to 10% of TiO₂, 0.1% to 10% of CeO₂, and 0% to 3.5% of R₂O in terms of mass % based on oxides.

### <Method for Producing Glass>

The glass according to the present embodiment can be produced by a general method. For example, raw materials of components of the glass are blended, and then heated and melted in a glass melting furnace. Thereafter, the glass is homogenized by a known method and molded into a desired shape such as a glass plate, followed by annealing.

Examples of a molding method for a glass plate include a float method, a press method, a fusion method, and a down-draw method. Particularly, a float method suitable for mass production is preferred. As a continuous molding method other than the float method, that is, a fusion method and a down-draw method are also preferred.

Thereafter, the molded glass is subjected to a grinding treatment, a polishing treatment, and an etching treatment to form a glass substrate. A thickness of the glass substrate can be adjusted to a desired thickness based on conditions of the treatments. Specific examples of etching include a method of polishing the glass surface by immersing the glass substrate in a solution containing hydrofluoric acid or the like and etching the glass substrate.

The glass according to the present embodiment preferably includes a conductive film on at least one surface. Examples of a component of the conductive film include In₂O₃, SnO₂, and ZnO. A thickness of the conductive film is preferably 100,000 nm or less, and more preferably 80,000 nm or less, 50,000 nm or less, 10,000 nm or less, 5,000 nm or less, 1,000 nm or less, 500 nm or less, or 100 nm or less. The thickness is not particularly specified in lower limit, and is, for example, 1 nm or more, and more preferably 5 nm or more, or 10 nm or more.

The glass according to the present embodiment preferably includes an antireflection film on at least one surface. Examples of a component of the antireflection film include MgF₂, CrNi, Ag, SiOₓ, TiOₓ, Ta₂O₅, and Al₂O₃.

The antireflection film is not limited to a single layer, and may be a multilayer in which a plurality of components are combined. A thickness of the antireflection film is preferably 100,000 nm or less, and more preferably 80,000 nm or less, 50,000 nm or less, 10,000 nm or less, 5,000 nm or less, 1,000 nm or less, 500 nm or less, or 100 nm or less. The thickness is not particularly specified in lower limit, and is, for example, 1 nm or more, and more preferably 5 nm or more, or 10 nm or more.

### Application

The glass according to the present embodiment is suitably used as a solar cell cover glass (for example, a solar cell cover glass for a space satellite), an electron-beam shielding glass, and a UV-blocking glass. The glass according to the present embodiment has excellent electron beam resistance and ultraviolet ray shielding effect, has an excellent strength, and can be increased in size, as compared with those in the related art, and is thus more suitable as a solar cell cover glass, which is required to have these properties.

### EXAMPLES

Hereinafter, the present invention is specifically described with reference to Examples, but the present invention is not limited thereto.

### (Preparation of Glass)

Generally used glass raw materials such as oxides, hydroxides, carbonates, or nitrates were appropriately selected such that glasses shown in Tables 1 to 6 have the glass compositions shown in the tables in terms of mass % based on oxides, charged into a platinum crucible, and melted by heating to a high temperature of 1,550° C. to 1,650° C. or higher in an electric furnace, and thereafter, the glass melt was poured onto a carbon mold and kept at Tg+50° C. for 1 hour, and then cooled at a rate of 1.0° C./min to obtain a glass block. The obtained glass block was cut, ground, and polished to prepare a glass sample having a predetermined size, and the physical properties were evaluated.

### (Evaluation of Properties)

The properties of the obtained glass substrate were evaluated by the following procedures.

### [Specific Gravity]

The specific gravity was measured by using the Archimedes method.

### [Young's Modulus]

The Young's modulus was measured by using the ultrasonic pulse method (JIS R1602, 1995). In the measurement, a glass substrate having a size of 30 mm in length×30 mm in width×1 mm in thickness was used.

[Average Thermal Expansion Coefficient CTE (50 to 200) [ppm/K]]

The average thermal expansion coefficient was measured using a differential thermal expansion meter according to a method defined in JIS R3102 (1995). A measurement temperature range was 50° C. to 200° C., and the unit was [×10⁻⁶/K]. In the measurement, a glass substrate having a size of 25 mm in length×6 mm in width×0.8 mm in thickness was used.

### (β-OH)

The transmittance of the glass sample was measured using FT-IR, and the β-OH was determined using the following equation. In the measurement, a glass substrate having a size of 30 mm in length×30 mm in width×1 mm in thickness was used.

$$β - OH = ( \frac{1}{X} ) {log}_{10} ( \frac{{T}_{ref}}{{T}_{OH}} ) \qquad [ Math . 4 ]$$

X: thickness (mm) of glass
T_{ref}: transmittance (%) at reference wavelength of 3846 cm⁻¹
T_{OH}: minimum transmittance (%) in a vicinity of hydroxy group absorption wavelength of 3600 cm⁻¹

### [K_{IC}]

The “fracture toughness value” can be measured by using a DCDC method (Acta metall. mater. Vol. 43, pp. 3453-3458, 1995).

### [Transmittance]

The transmittance was measured using a spectrophotometer (trade name: U-4100) manufactured by Hitachi High-Tech Corporation. In the measurement, glass substrates having a size of 25 mm in length×25 mm in width×100 μm in thickness and 25 mm in length×25 mm in width×50 μm in thickness were used.

[Average Absorbance Change Amount in Wavelength Range of 400 nm to 800 nm During Electron Beam Irradiation (in Terms of Thickness of 100 μm)]

In the electron beam irradiation, a glass substrate to be irradiated was left to stand horizontally on a table, and the glass substrate was irradiated with an electron beam of 1×10¹⁵ electrons/cm² at an energy amount of 1 MeV using an electron beam irradiation apparatus (model number: EPS-3000 kV manufactured by NHV Corporation). In the measurement, a glass substrate having a size of 20 mm in length×20 mm in width×0.5 mm in thickness was used. The transmittance was measured before the electron beam irradiation, and the transmittance was measured again after the electron beam irradiation was performed on each glass substrate. The measurement was performed within one week after the electron beam irradiation. The absorbance before and after the electron beam irradiation was calculated based on the measured transmittance and converted into the absorbance at a thickness of 100 μm, and then the average absorbance change amount in the wavelength range of 400 nm to 800 nm was calculated according to the following equation.

$$\frac{{\sum }_{λ = 400}^{800} ( {A}_{after} [ λ ] - {A}_{before} [ λ ] )}{400} \qquad [ Math . 5 ]$$

A [λ]: absorbance at wavelength λ
A_{after} [λ]: absorbance at wavelength λ after electron beam irradiation
A_{before} [λ]: absorbance at wavelength λ before electron beam irradiation

### [Warpage Amount]

For the glass in each example, the warpage amount was calculated based on Bi-Metal warpage calculation defined according to the following equation. Specifically, the absolute value of the warpage amount δ was calculated according to the following equation.

$$δ = \frac{6 {L}^{2} ( {α}_{2} - {α}_{1} ) ( {T}_{min} - {T}_{max} ) {( 1 + m )}^{2}}{8 h [ 3 {( 1 + m )}^{2} + ( 1 + mn ) \{ {m}^{2} + {( mn )}^{- 1} \} ]} \qquad [ Math . 6 ]$$

L: length [mm] in warpage direction of glass
α₁: thermal expansion coefficient [ppm/K] of solar cell
α₂: thermal expansion coefficient [ppm/K] of glass
E₁: Young's modulus [GPa] of solar cell
E₂: Young's modulus [GPa] of glass
Tₘₐₓ: assumed maximum temperature (° C.) Tₘᵢₙ: assumed minimum temperature (° C.)
a₁: thickness [mm] of solar cell
a₂: thickness [mm] of glass
h: a₁+a₂ [mm]
m: a₁/a₂
n: E₁/E₂
δ: warpage amount [mm]

It was assumed that single crystal silicon was used for the solar cell with reference to “MAXEON™ GENIII SOLAR CELLS” manufactured by Sunpower. Therefore, the thermal expansion coefficient and the Young's modulus of the solar cell were α₁=3.2 ppm/° C. and E₁=190 GPa, respectively, assuming that single crystal silicon was used. As the thermal expansion coefficient of the glass, a value of the average thermal expansion coefficient (ppm/° C.) in a range of 50° C. to 200° C. was used. The thickness of the solar cell was assumed to be 0.15 mm.

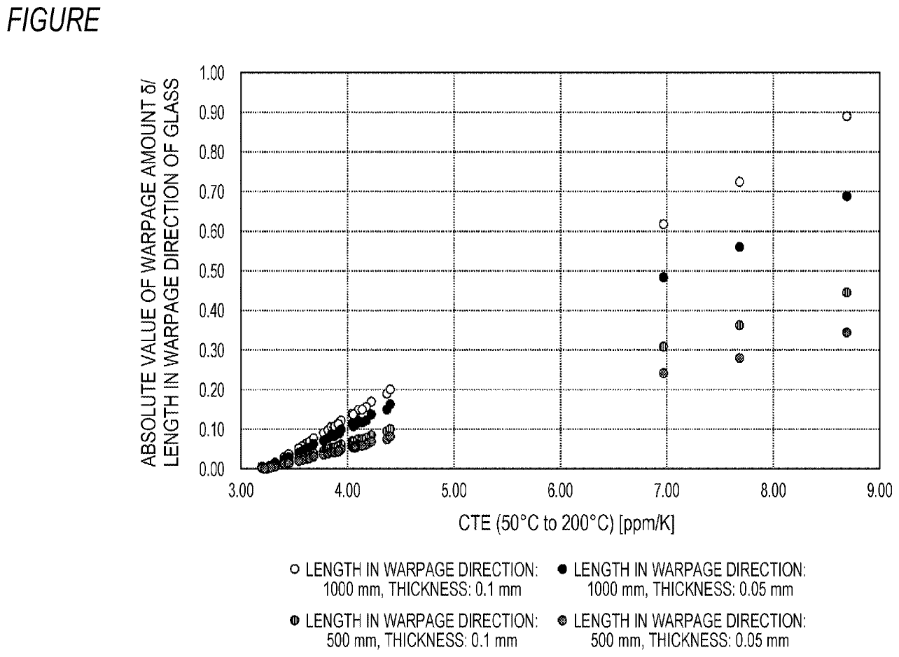

Tables 1 to 6 show the glass composition in terms of mass % based on oxides and the results of evaluating of the properties. The FIG. 1s a diagram showing the correlation between the average thermal expansion coefficient and the (absolute value of warpage amount δ/length in warpage direction of glass).

In Tables 1 to 6, Examples 1 to 39 are Inventive Examples, and Examples 40 to 42 are Comparative Examples. In Tables 1 to 6, the italic word indicates a calculated value, and “—” indicates that no evaluation is performed.

In the case of considering the transmittance at 50 μm based on the transmittance at 100 μm, the transmittance can be calculated according to the Beer-Lambert law by assuming that the amount of the light absorbing element is half.

TABLE 1

| Example | 1 | 2 | 3 | 4 | 5 | 6 | 7 |
|---|---|---|---|---|---|---|---|
| SiO₂ | 61.0 | 57.3 | 59.1 | 58.2 | 56.6 | 56.9 | 56.5 |
| Al₂O₃ | 12.6 | 17.3 | 17.8 | 16.9 | 17.1 | 16.6 | 17.0 |
| B₂O₃ | 4.4 | 12.1 | 11.9 | 12.5 | 11.9 | 11.8 | 12.4 |
| MgO | 8.8 | 1.2 | 1.2 | 1.1 | 1.2 | 1.2 | 1.2 |
| CaO | 4.5 | 6.4 | 6.9 | 6.5 | 6.4 | 6.2 | 6.3 |
| SrO | 3.8 | 0.9 | 0.8 | 0.7 | 0.9 | 0.9 | 0.9 |
| BaO | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 0.05 | 0.06 | 0.06 | 0.04 | 0.48 | 0.88 | 0.05 |
| K₂O | 0.01 | 0.01 | 0.01 | 0.01 | 0.46 | 0.88 | 0.01 |
| ZrO₂ | 0.0 | 0.0 | 0.0 | 0.0 | 0.0 | 0.0 | 0.0 |
| TiO₂ | 2.8 | 2.7 | 0.0 | 0.0 | 2.8 | 2.7 | 5.5 |
| CeO₂ | 1.8 | 1.8 | 2.0 | 3.7 | 1.8 | 1.8 | 0.0 |
| Fe₂O₃ | 0.005 | 0.004 | 0.011 | 0.010 | 0.005 | 0.005 | 0.005 |
| SnO₂ | 0.2 | 0.2 | 0.2 | 0.2 | 0.2 | 0.2 | 0.2 |
| SO₃ | 0.021 | 0.008 | 0.028 | 0.012 | 0.006 | 0.005 | 0.011 |
| Cl | 0.02 | 0.01 | 0.0 | 0.0 | 0.0 | 0.0 | 0.01 |
| Total | 100.0 | 100.0 | 100.0 | 100.0 | 100.0 | 100.0 | 100.0 |
| Li₂O + Na₂O + K₂O | 0.1 | 0.1 | 0.1 | 0.0 | 0.9 | 1.8 | 0.1 |
| CeO₂/Fe₂O₃ | 371 | 408 | 172 | 372 | 379 | 396 | 0 |
| 5CeO₂ + TiO₂ | 11.6 | 11.7 | 9.8 | 18.5 | 11.9 | 11.7 | 5.5 |
| Specific gravity p | 2.59 | 2.45 | 2.42 | 2.46 | 2.45 | 2.45 | 2.41 |
| Young's modulus E [GPa] | 89.2 | 75.5 | 74.7 | 76.3 | 75.9 | 76.2 | 74.8 |
| E/p [GPa] | 34.4 | 30.9 | 30.9 | 31.1 | 31.1 | 31.0 | 31.0 |
| CTE (50° C. to 200° C.) [ppm/K] | 4.04 | 3.32 | 3.25 | 3.41 | 3.61 | 3.92 | 3.24 |
| β-OH [mm⁻¹] | 0.14 | 0.21 | 0.18 | 0.21 | 0.14 | 0.18 | 0.16 |
| Average absorbance change amount | 0.003 | 0.003 | 0.003 | 0.002 | 0.003 | 0.003 | — |
| in a wavelength range of 400 nm to | | | | | | | |
| 800 nm during electron beam irradiation | | | | | | | |
| [in terms of thickness of 100 μm] | | | | | | | |
| K_{IC} [MPa · m^{1/2}] | 0.83 | 0.86 | 0.85 | 0.85 | 0.86 | 0.85 | 0.87 |
| Transmittance at 100 μm at wavelength of 400 nm | 81 | 88 | 91 | 91 | 87 | 85 | 90 |
| Transmittance at 100 μm at wavelength of 300 nm | 0 | 2 | 3 | 0 | 1 | 1 | 0 |
| Transmittance at 100 μm ([at wavelength | 81 | 87 | 89 | 91 | 86 | 84 | 90 |
| of 400]-[at wavelength of 300 nm]) | | | | | | | |
| Wavelength [nm] exhibiting transmittance | 344 | 333 | — | — | 336 | 338 | 325 |
| of 50% at thickness of 100 μm | | | | | | | |
| Transmittance at 50 μm [at wavelength of 400 nm] | 88 | 90 | 92 | 91 | 89 | 89 | 91 |
| Transmittance at 50 μm [at wavelength of 300 nm] | 3 | 4 | 16 | 2 | 3 | 3 | 5 |
| Transmittance at 50 μm ([at wavelength | 86 | 87 | 76 | 89 | 87 | 86 | 86 |
| of 400]-[at wavelength of 300 nm]) | | | | | | | |
| Wavelength [nm] exhibiting transmittance | 329 | 325 | 319 | 327 | 327 | 328 | 318 |
| of 50% at thickness of 50 μm | | | | | | | |
| Absolute value of warpage amount | 0.14 | 0.02 | 0.00 | 0.03 | 0.06 | 0.11 | 0.00 |
| δ/length in warpage direction of glass | | | | | | | |
| (length in warpage direction: 1000 mm, | | | | | | | |
| thickness: 0.1 mm) | | | | | | | |
| Absolute value of warpage amount | 0.11 | 0.01 | 0.00 | 0.02 | 0.05 | 0.09 | 0.00 |
| δ/length in warpage direction of glass | | | | | | | |
| (length in warpage direction: | | | | | | | |
| 1000 mm, thickness: 0.05 mm) | | | | | | | |
| Absolute value of warpage amount | 0.07 | 0.01 | 0.00 | 0.01 | 0.03 | 0.06 | 0.00 |
| δ/length in warpage direction of glass | | | | | | | |
| (length in warpage direction: 500 mm, | | | | | | | |
| thickness: 0.1 mm) | | | | | | | |
| Absolute value of warpage amount | 0.06 | 0.01 | 0.00 | 0.01 | 0.02 | 0.04 | 0.00 |
| δ/length in warpage direction of glass | | | | | | | |
| (length in warpage direction: 500 mm, | | | | | | | |
| thickness: 0.05 mm) | | | | | | | |

TABLE 2

| Example | 8 | 9 | 10 | 11 | 12 | 13 | 14 |
|---|---|---|---|---|---|---|---|
| SiO₂ | 59.6 | 58.4 | 56.5 | 56.5 | 56.5 | 55.9 | 58.4 |
| Al₂O₃ | 17.5 | 17.2 | 16.3 | 16.3 | 16.3 | 16.2 | 18.9 |
| B₂O₃ | 12.0 | 11.8 | 7.7 | 7.7 | 7.7 | 7.6 | 1.2 |
| MgO | 1.1 | 1.1 | 2.9 | 2.9 | 2.9 | 2.9 | 5.3 |
| CaO | 6.7 | 6.6 | 3.6 | 3.6 | 3.6 | 3.6 | 4.4 |
| SrO | 0.9 | 0.9 | 7.7 | 7.7 | 7.7 | 7.6 | 6.6 |
| BaO | 0.0 | 0.0 | 0.0 | 0.0 | 0.0 | 0.0 | 0.1 |
| Li₂O | 0.0 | 0.0 | 0.0 | 0.0 | 0.0 | 0.0 | 0.0 |
| Na₂O | 0.06 | 0.06 | 0.0 | 0.0 | 0.5 | 1 | 0.0 |
| K₂O | 0.01 | 0.01 | 0.0 | 0.0 | 0.5 | 1 | 0.0 |
| ZrO₂ | 0.0 | 0.0 | 0.0 | 0.0 | 0.0 | 0.0 | 0.0 |
| TiO₂ | 0.0 | 0.0 | 2.0 | 1.0 | 1.0 | 1.0 | 1.0 |
| CeO₂ | 1.9 | 3.7 | 3.0 | 4.0 | 3.0 | 3.0 | 4.0 |
| Fe₂O₃ | 0.004 | 0.005 | 0.005 | 0.005 | 0.005 | 0.005 | 0.005 |
| SnO₂ | 0.0 | 0.0 | 0.2 | 0.2 | 0.2 | 0.2 | 0.2 |
| SO₃ | 0.011 | 0.014 | 0.0 | 0.0 | 0.0 | 0.0 | 0.0 |
| Cl | 0.15 | 0.16 | 0.0 | 0.0 | 0.0 | 0.0 | 0.0 |
| Total | 100.0 | 100.0 | 100.0 | 100.0 | 100.0 | 100.0 | 100.0 |
| Li₂O + Na₂O + K₂O | 0.1 | 0.1 | 0.0 | 0.0 | 1.0 | 2.0 | 0.0 |
| CeO₂/Fe₂O₃ | 433 | 731 | 600 | 800 | 600 | 600 | 800 |
| 5CeO₂ + TiO₂ | 9.4 | 18.7 | 17.0 | 21.0 | 16.0 | 16.0 | 21.0 |
| Specific gravity p | 2.42 | 2.46 | 2.58 | 2.59 | 2.58 | 2.58 | 2.67 |
| Young's modulus E [GPa] | 74.6 | 75.6 | 77.7 | 78.1 | 77.9 | 78.3 | 88.1 |
| E/p [GPa] | 30.9 | 30.8 | 30.1 | 30.1 | 30.3 | 30.3 | 33.0 |
| CTE (50° C. to 200° C.) [ppm/K] | 3.32 | 3.41 | 3.77 | 3.82 | 4.07 | 4.37 | 3.85 |
| β-OH [mm⁻¹] | 0.17 | 0.18 | — | — | — | — | — |
| Average absorbance change amount in | 0.002 | 0.001 | 0.003 | 0.002 | 0.003 | 0.003 | 0.002 |
| a wavelength range of 400 nm to | | | | | | | |
| 800 nm during electron beam irradiation | | | | | | | |
| [in terms of thickness of 100 μm] | | | | | | | |
| K_{IC} [MPa · m^{1/2}] | 0.85 | 0.85 | 0.84 | 0.83 | 0.83 | 0.83 | 0.81 |
| Transmittance at 100 μm at wavelength of 400 nm | 90 | 88 | 89 | 88 | 87 | 85 | 84 |
| Transmittance at 100 μm at wavelength of 300 nm | 2 | 0 | 0 | 0 | 0 | 0 | 0 |
| Transmittance at 100 μm ([at wavelength | 88 | 88 | 89 | 88 | 87 | 85 | 84 |
| of 400]-[at wavelength of 300 nm]) | | | | | | | |
| Wavelength [nm] exhibiting transmittance | — | — | — | — | — | — | — |
| of 50% at thickness of 100 μm | | | | | | | |
| Transmittance at 50 μm [at wavelength of 400 nm] | 91 | 90 | 90 | 90 | 89 | 88 | 88 |
| Transmittance at 50 μm [at wavelength of 300 nm] | 10 | 1 | 2 | 1 | 2 | 2 | 1 |
| Transmittance at 50 μm ([at wavelength | 81 | 89 | 88 | 89 | 87 | 86 | 87 |
| of 400]-[at wavelength of 300 nm]) | | | | | | | |
| Wavelength [nm] exhibiting transmittance | 323 | 333 | 330 | 332 | 330 | 332 | 335 |
| of 50% at thickness of 50 μm | | | | | | | |
| Absolute value of warpage amount δ/length | 0.02 | 0.03 | 0.09 | 0.10 | 0.14 | 0.19 | 0.11 |
| in warpage direction of glass | | | | | | | |
| (length in warpage direction: 1000 mm, | | | | | | | |
| thickness: 0.1 mm) | | | | | | | |
| Absolute value of warpage amount | 0.01 | 0.02 | 0.07 | 0.08 | 0.11 | 0.15 | 0.09 |
| δ/length in warpage direction of glass | | | | | | | |
| (length in warpage direction: 1000 mm, | | | | | | | |
| thickness: 0.05 mm) | | | | | | | |
| Absolute value of warpage amount δ/length | 0.01 | 0.01 | 0.05 | 0.05 | 0.07 | 0.09 | 0.05 |
| in warpage direction of glass | | | | | | | |
| (length in warpage direction: 500 mm, | | | | | | | |
| thickness: 0.1 mm) | | | | | | | |
| Absolute value of warpage amount | 0.01 | 0.01 | 0.04 | 0.04 | 0.06 | 0.07 | 0.04 |
| δ/length in warpage direction of glass | | | | | | | |
| (length in warpage direction: 500 mm, | | | | | | | |
| thickness: 0.05 mm) | | | | | | | |

TABLE 3

| Example | 15 | 16 | 17 | 18 | 19 | 20 | 21 |
|---|---|---|---|---|---|---|---|
| SiO₂ | 58.4 | 57.7 | 58.9 | 58.3 | 55.5 | 54.9 | 54.4 |
| Al₂O₃ | 18.9 | 18.7 | 19.5 | 19.3 | 17.9 | 17.7 | 17.5 |
| B₂O₃ | 1.2 | 1.2 | 4.7 | 4.7 | 9.7 | 9.6 | 9.5 |
| MgO | 5.3 | 5.3 | 4.7 | 4.7 | 2.6 | 2.6 | 2.6 |
| CaO | 4.4 | 4.3 | 5.4 | 5.4 | 1.6 | 1.6 | 1.5 |
| SrO | 6.6 | 6.5 | 1.5 | 1.5 | 7.5 | 7.4 | 7.3 |
| BaO | 0.1 | 0.1 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 0.5 | 1 | 1 | 1.5 | 0.0 | 1 | 1.5 |
| K₂O | 0.5 | 1 | 1 | 1.5 | 0.0 | 1 | 1.5 |
| ZrO₂ | 0.0 | 0.0 | 0.0 | 0.0 | 0.0 | 0.0 | 0.0 |
| TiO₂ | 1.0 | 1.0 | 1.0 | 1.0 | 2.0 | 1.0 | 1.0 |
| CeO₂ | 3.0 | 3.0 | 2.0 | 2.0 | 3.0 | 3.0 | 3.0 |
| Fe₂O₃ | 0.005 | 0.005 | 0.005 | 0.005 | 0.005 | 0.005 | 0.005 |
| SnO₂ | 0.2 | 0.2 | 0.2 | 0.2 | 0.2 | 0.2 | 0.2 |
| SO₃ | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 |
| Total | 100.0 | 100.0 | 100.0 | 100.0 | 100.0 | 100.0 | 100.0 |
| Li₂O + Na₂O + K₂O | 1.0 | 2.0 | 2.0 | 3.0 | 0.0 | 2.0 | 3.0 |
| CeO₂/Fe₂O₃ | 600 | 600 | 400 | 400 | 600 | 600 | 600 |
| 5CeO₂ + TiO₂ | 16.0 | 16.0 | 11.0 | 11.0 | 17.0 | 16.0 | 16.0 |
| Specific gravity p | 2.66 | 2.66 | 2.52 | 2.53 | 2.53 | 2.53 | 2.53 |
| Young's modulus E [GPa] | 87.9 | 88.3 | 86.4 | 86.7 | 77.4 | 77.6 | 78.0 |
| E/p [GPa] | 33.1 | 33.2 | 34.3 | 34.3 | 30.6 | 30.7 | 30.8 |
| CTE (50° C. to 200° C.) [ppm/K] | 4.10 | 4.40 | 3.92 | 4.22 | 3.31 | 3.61 | 3.91 |
| β-OH [mm⁻¹] | — | — | — | — | — | — | — |
| Average absorbance change amount | 0.003 | 0.003 | 0.003 | 0.003 | 0.003 | 0.003 | 0.003 |
| in a wavelength range of 400 nm to | | | | | | | |
| 800 nm during electron beam irradiation | | | | | | | |
| [in terms of thickness of 100 μm] | | | | | | | |
| K_{IC} [MPa · m^{1/2}] | 0.8 | 0.81 | 0.83 | 0.82 | 0.85 | 0.84 | 0.83 |
| Transmittance at 100 μm at wavelength of 400 nm | 83 | 81 | 85 | 83 | 89 | 85 | 83 |
| Transmittance at 100 μm at wavelength of 300 nm | 0 | 0 | 0 | 0 | 0 | 0 | 0 |
| Transmittance at 100 μm ([at wavelength | 83 | 81 | 85 | 83 | 89 | 85 | 83 |
| of 400]-[at wavelength of 300 nm]) | | | | | | | |
| Wavelength [nm] exhibiting transmittance | — | — | — | — | — | — | — |
| of 50% at thickness of 100 μm | | | | | | | |
| Transmittance at 50 μm [at wavelength of 400 nm] | 87 | 86 | 88 | 87 | 90 | 88 | 87 |
| Transmittance at 50 μm [at wavelength of 300 nm] | 2 | 1 | 5 | 4 | 2 | 7 | 2 |
| Transmittance at 50 μm ([at wavelength | 85 | 84 | 84 | 83 | 88 | 86 | 85 |
| of 400]-[at wavelength of 300 nm]) | | | | | | | |
| Wavelength [nm] exhibiting transmittance | 333 | 335 | 328 | 330 | 330 | 332 | 334 |
| of 50% at thickness of 50 μm | | | | | | | |
| Absolute value of warpage amount | 0.15 | 0.20 | 0.12 | 0.17 | 0.01 | 0.06 | 0.11 |
| δ/length in warpage direction of glass | | | | | | | |
| (length in warpage direction: 1000 mm, | | | | | | | |
| thickness: 0.1 mm) | | | | | | | |
| Absolute value of warpage amount | 0.12 | 0.16 | 0.10 | 0.14 | 0.01 | 0.05 | 0.09 |
| δ/length in warpage direction of glass | | | | | | | |
| (length in warpage direction: 1000 mm, | | | | | | | |
| thickness: 0.05 mm) | | | | | | | |
| Absolute value of warpage amount | 0.07 | 0.10 | 0.06 | 0.08 | 0.01 | 0.03 | 0.06 |
| δ/length in warpage direction of glass | | | | | | | |
| (length in warpage direction: 500 mm, | | | | | | | |
| thickness: 0.1 mm) | | | | | | | |
| Absolute value of warpage amount | 0.06 | 0.08 | 0.05 | 0.07 | 0.01 | 0.02 | 0.04 |
| δ/length in warpage direction of glass | | | | | | | |
| (length in warpage direction: 500 mm, | | | | | | | |
| thickness: 0.05 mm) | | | | | | | |

TABLE 4

| Example | 22 | 23 | 24 | 25 | 26 | 27 | 28 |
|---|---|---|---|---|---|---|---|
| SiO₂ | 55.9 | 57.7 | 54.9 | 55.9 | 56.5 | 52.6 | 59.6 |
| Al₂O₃ | 16.2 | 18.7 | 17.7 | 16.2 | 18.3 | 17.0 | 17.5 |
| B₂O₃ | 7.6 | 1.2 | 9.6 | 7.6 | 1.2 | 9.2 | 11.9 |
| MgO | 2.9 | 5.3 | 2.6 | 2.9 | 5.1 | 2.5 | 1.1 |
| CaO | 3.6 | 4.3 | 1.6 | 3.6 | 4.2 | 1.5 | 6.6 |
| SrO | 7.6 | 6.5 | 7.4 | 7.6 | 6.4 | 7.1 | 1.0 |
| BaO | 0.0 | 0.1 | 0.0 | 0.0 | 0.1 | 0.0 | 0.0 |
| Li₂O | 0.0 | 0.0 | 0.0 | 0.0 | 0.0 | 0.0 | 0.0 |
| Na₂O | 0.0 | 0.0 | 0.0 | 0.0 | 0.0 | 0.0 | 0.0 |
| K₂O | 0.0 | 0.0 | 0.0 | 0.0 | 0.0 | 0.0 | 0.0 |
| ZrO₂ | 0.0 | 0.0 | 0.0 | 0.0 | 0.0 | 0.0 | 0.0 |
| TiO₂ | 0.0 | 0.0 | 0.0 | 6.0 | 8.0 | 10.0 | 1.0 |
| CeO₂ | 6.0 | 6.0 | 6.0 | 0.0 | 0.0 | 0.0 | 1.0 |
| Fe₂O₃ | 0.005 | 0.005 | 0.005 | 0.005 | 0.005 | 0.005 | 0.005 |
| SnO₂ | 0.2 | 0.2 | 0.2 | 0.2 | 0.2 | 0.2 | 0.2 |
| SO₃ | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 |
| Total | 100.0 | 100.0 | 100.0 | 100.0 | 100.0 | 100.0 | 99.9 |
| Li₂O + Na₂O + K₂O | 0.0 | 0.0 | 0.0 | 0.0 | 0.0 | 0.0 | 0.0 |
| CeO₂/Fe₂O₃ | 1200 | 1200 | 1200 | 0 | 0 | 0 | 200 |
| 5CeO₂ + TiO₂ | 30.0 | 30.0 | 30.0 | 6.0 | 8.0 | 10.0 | 6.0 |
| Specific gravity p | 2.62 | 2.70 | 2.57 | 2.54 | 2.64 | 2.52 | 2.40 |
| Young's modulus E [GPa] | 79.0 | 89.0 | 78.7 | 76.6 | 86.8 | 76.7 | 74.9 |
| E/p [GPa] | 30.1 | 32.9 | 30.6 | 30.1 | 32.9 | 30.5 | 31.2 |
| CTE (50° C. to 200° C.) [ppm/K] | 3.91 | 3.94 | 3.45 | 3.65 | 3.68 | 3.20 | 3.27 |
| β-OH [mm⁻¹] | — | — | — | — | — | — | — |
| Average absorbance change amount | 0.001 | 0.001 | 0.001 | — | — | — | 0.005 |
| in a wavelength range of 400 nm to | | | | | | | |
| 800 nm during electron beam irradiation | | | | | | | |
| [in terms of thickness of 100 μm] | | | | | | | |
| K_{IC} [MPa · m^{1/2}] | 0.83 | 0.81 | 0.85 | 0.84 | 0.83 | 0.87 | 0.85 |
| Transmittance at 100 μm at | 87 | 83 | 87 | 90 | 90 | 90 | 90 |
| wavelength of 400 nm | | | | | | | |
| Transmittance at 100 μm at | 0 | 0 | 0 | 0 | 0 | 0 | 4 |
| wavelength of 300 nm | | | | | | | |
| Transmittance at 100 μm ([at wavelength | 87 | 83 | 87 | 90 | 90 | 90 | 86 |
| of 400]-[at wavelength of 300 nm]) | | | | | | | |
| Wavelength [nm] exhibiting transmittance | — | — | — | — | — | — | — |
| of 50% at thickness of 100 μm | | | | | | | |
| Transmittance at 50 μm [at wavelength of 400 nm] | 89 | 87 | 89 | 91 | 91 | 90 | 91 |
| Transmittance at 50 μm [at wavelength of 300 nm] | 0 | 0 | 0 | 4 | 1 | 1 | 20 |
| Transmittance at 50 μm ([at wavelength | 89 | 87 | 89 | 87 | 89 | 90 | 71 |
| of 400]-[at wavelength of 300 nm]) | | | | | | | |
| Wavelength [nm] exhibiting transmittance | 337 | 339 | 337 | 319 | 322 | 325 | 317 |
| of 50% at thickness of 50 μm | | | | | | | |
| Absolute value of warpage amount δ/length | 0.11 | 0.12 | 0.04 | 0.07 | 0.08 | 0.01 | 0.01 |
| in warpage direction of glass | | | | | | | |
| (length in warpage direction: 1000 mm, | | | | | | | |
| thickness: 0.1 mm) | | | | | | | |
| Absolute value of warpage amount δ/length | 0.09 | 0.10 | 0.03 | 0.05 | 0.06 | 0.00 | 0.01 |
| in warpage direction of glass | | | | | | | |
| (length in warpage direction: 1000 mm, | | | | | | | |
| thickness: 0.05 mm) | | | | | | | |
| Absolute value of warpage amount δ/length | 0.06 | 0.06 | 0.02 | 0.03 | 0.04 | 0.00 | 0.00 |
| in warpage direction of glass | | | | | | | |
| (length in warpage direction: 500 mm, | | | | | | | |
| thickness: 0.1 mm) | | | | | | | |
| Absolute value of warpage amount | 0.04 | 0.05 | 0.01 | 0.03 | 0.03 | 0.00 | 0.00 |
| δ/length in warpage direction of glass | | | | | | | |
| (length in warpage direction: 500 mm, | | | | | | | |
| thickness: 0.05 mm) | | | | | | | |

TABLE 5

| Example | 29 | 30 | 31 | 32 | 33 | 34 | 35 |
|---|---|---|---|---|---|---|---|
| SiO₂ | 59.0 | 59.0 | 57.8 | 58.4 | 56.6 | 57.8 | 56.6 |
| Al₂O₃ | 17.3 | 17.3 | 17.0 | 17.1 | 16.6 | 17.0 | 16.6 |
| B₂O₃ | 11.8 | 11.8 | 11.5 | 11.7 | 11.3 | 11.5 | 11.3 |
| MgO | 1.1 | 1.1 | 1.1 | 1.1 | 1.1 | 1.1 | 1.1 |
| CaO | 6.6 | 6.6 | 6.4 | 6.5 | 6.3 | 6.4 | 6.3 |
| SrO | 0.9 | 0.9 | 0.9 | 0.9 | 0.9 | 0.9 | 0.9 |
| BaO | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 0.5 | 0.0 | 1 | 0.0 | 1.5 | 0.0 | 1 |
| K₂O | 0.5 | 0.0 | 1 | 0.0 | 1.5 | 0.0 | 1 |
| ZrO₂ | 0.0 | 0.0 | 0.0 | 0.0 | 0.0 | 0.0 | 0.0 |
| TiO₂ | 1.0 | 2.0 | 2.0 | 3.0 | 3.0 | 4.0 | 4.0 |
| CeO₂ | 1.0 | 1.0 | 1.0 | 1.0 | 1.0 | 1.0 | 1.0 |
| Fe₂O₃ | 0.005 | 0.005 | 0.005 | 0.005 | 0.005 | 0.005 | 0.005 |
| SnO₂ | 0.2 | 0.2 | 0.2 | 0.2 | 0.2 | 0.2 | 0.2 |
| SO₃ | 0.0 | 0.0 | 0.0 | 0.0 | 0.0 | 0.0 | 0.0 |
| Cl | 0.0 | 0.0 | 0.0 | 0.0 | 0.0 | 0.0 | 0.0 |
| Total | 99.9 | 99.9 | 99.9 | 99.9 | 99.9 | 99.9 | 99.9 |
| Li₂O + Na₂O + K₂O | 1.0 | 0.0 | 2.0 | 0.1 | 3.0 | 0.1 | 2.0 |
| CeO₂/Fe₂O₃ | 200 | 200 | 200 | 200 | 200 | 200 | 200 |
| 5CeO₂ + TiO₂ | 6.0 | 7.0 | 7.0 | 8.0 | 8.0 | 9.0 | 9.0 |
| Specific gravity p | 2.41 | 2.41 | 2.42 | 2.41 | 2.43 | 2.42 | 2.43 |
| Young's modulus E [GPa] | 75.2 | 75.0 | 75.7 | 75.1 | 76.1 | 75.2 | 75.9 |
| E/p [GPa] | 31.3 | 31.1 | 31.3 | 31.1 | 31.4 | 31.1 | 31.3 |
| CTE (50° C. to 200° C.) [ppm/K] | 3.57 | 3.28 | 3.87 | 3.28 | 4.18 | 3.28 | 3.88 |
| β-OH [mm⁻¹] | — | — | — | — | — | — | — |
| Average absorbance change amount | 0.005 | 0.003 | 0.003 | 0.003 | 0.003 | 0.002 | 0.002 |
| in a wavelength range of 400 nm to | | | | | | | |
| 800 nm during electron beam irradiation | | | | | | | |
| [in terms of thickness of 100 μm] | | | | | | | |
| K_{IC} [MPa · m^{1/2}] | 0.85 | 0.85 | 0.85 | 0.86 | 0.84 | 0.86 | 0.85 |
| Transmittance at 100 μm at wavelength of 400 nm | 88 | 90 | 86 | 90 | 84 | 90 | 86 |
| Transmittance at 100 μm at wavelength of 300 nm | 3 | 2 | 1 | 1 | 0 | 0 | 0 |
| Transmittance at 100 μm ([at wavelength | 85 | 89 | 85 | 90 | 84 | 90 | 86 |
| of 400]-[at wavelength of 300 nm]) | | | | | | | |
| Wavelength [nm] exhibiting transmittance | — | — | — | — | — | — | — |
| of 50% at thickness of 100 μm | | | | | | | |
| Transmittance at 50 μm [at wavelength of 400 nm] | 90 | 91 | 89 | 91 | 87 | 91 | 88 |
| Transmittance at 50 μm [at wavelength of 300 nm] | 16 | 12 | 8 | 7 | 4 | 4 | 3 |
| Transmittance at 50 μm ([at wavelength | 73 | 79 | 80 | 84 | 83 | 86 | 86 |
| of 400]-[at wavelength of 300 nm]) | | | | | | | |
| Wavelength [nm] exhibiting transmittance | 319 | 319 | 323 | 321 | 327 | 322 | 326 |
| of 50% at thickness of 50 μm | | | | | | | |
| Absolute value of warpage amount | 0.06 | 0.01 | 0.11 | 0.01 | 0.16 | 0.01 | 0.11 |
| δ/length in warpage direction of glass | | | | | | | |
| (length in warpage direction: | | | | | | | |
| 1000 mm, thickness: 0.1 mm) | | | | | | | |
| Absolute value of warpage amount | 0.04 | 0.01 | 0.08 | 0.01 | 0.12 | 0.01 | 0.08 |
| δ/length in warpage direction of glass | | | | | | | |
| (length in warpage direction: 1000 mm, | | | | | | | |
| thickness: 0.05 mm) | | | | | | | |
| Absolute value of warpage amount | 0.03 | 0.00 | 0.05 | 0.00 | 0.08 | 0.00 | 0.05 |
| δ/length in warpage direction of glass | | | | | | | |
| (length in warpage direction: 500 mm, | | | | | | | |
| thickness: 0.1 mm) | | | | | | | |
| Absolute value of warpage amount | 0.02 | 0.00 | 0.04 | 0.00 | 0.06 | 0.00 | 0.04 |
| δ/length in warpage direction of glass | | | | | | | |
| (length in warpage direction: 500 mm, | | | | | | | |
| thickness: 0.05 mm) | | | | | | | |

TABLE 6

| Example | 36 | 37 | 38 | 39 | 40 | 41 | 42 |
|---|---|---|---|---|---|---|---|
| SiO₂ | 58.4 | 56.6 | 55.3 | 55.3 | 69.2 | 61.0 | 61.1 |
| Al₂O | 17.1 | 16.6 | 16.3 | 16.3 | 5.2 | 14.0 | 6.9 |
| B₂O₃ | 11.7 | 11.3 | 11.1 | 11.1 | 0.0 | 5.3 | 11.3 |
| MgO | 1.1 | 1.1 | 1.0 | 1.0 | 3.9 | 2.8 | 0.0 |
| CaO | 6.5 | 6.3 | 6.2 | 6.2 | 6.5 | 0.0 | 0.0 |
| SrO | 0.9 | 0.9 | 0.9 | 0.9 | 0.0 | 0.0 | 0.0 |
| BaO | 0.0 | 0.0 | 0.0 | 0.0 | 0.0 | 0.0 | 3.5 |
| Li₂O | 0.0 | 0.0 | 0.0 | 0.0 | 0.0 | 0.0 | 0.0 |
| Na₂O | 1.0 | 1.0 | 0.5 | 1.5 | 15.0 | 13.5 | 11.7 |
| K₂O | 1.0 | 1.0 | 0.5 | 1.5 | 0.2 | 0.5 | 0.0 |
| ZrO₂ | 0.0 | 0.0 | 0.0 | 0.0 | 0.0 | 0.0 | 0.0 |
| TiO₂ | 0.0 | 0.0 | 8 | 6 | 0.0 | 0.0 | 0.9 |
| CeO₂ | 2 | 5 | 0.0 | 0.0 | 0.0 | 2.6 | 4.2 |
| Fe₂O₃ | 0.005 | 0.005 | 0.005 | 0.005 | 0.0 | 0.0 | 0.0 |
| SnO₂ | 0.2 | 0.2 | 0.2 | 0.2 | 0.0 | 0.3 | 0.4 |
| SO₃ | 0.0 | 0.0 | 0.0 | 0.0 | 0.0 | 0.010 | 0.006 |
| Cl | 0.0 | 0.0 | 0.0 | 0.0 | 0.0 | 0.00 | 0.0 |
| Total | 99.9 | 99.9 | 100.0 | 100.0 | 100.0 | 100.0 | 100.0 |
| LizO + Na₂O + K₂O | 2.0 | 2.0 | 1.0 | 3.0 | 15.2 | 14.0 | 11.7 |
| CeO₂/Fe₂O₃ | 400 | 1000 | 0 | 0 | — | 660 | — |
| 5CeO₂ + TiO₂ | 10.0 | 25.0 | 8.0 | 6.0 | 0.0 | 12.8 | 21.9 |
| Specific gravity p | 2.42 | 2.48 | 2.43 | 2.43 | 2.50 | 2.47 | 2.57 |
| Young's modulus E [GPa] | 76.0 | 77.5 | 75.5 | 76.0 | 72.9 | 72.5 | 76.4 |
| E/p [GPa] | 31.3 | 31.2 | 31.1 | 31.3 | 29.2 | 29.4 | 29.7 |
| CTE (50° C. to 200° C.) [ppm/K] | 3.92 | 4.06 | 3.54 | 4.14 | 8.69 | 7.68 | 6.97 |
| β-OH [mm⁻¹] | — | — | — | — | — | 0.15 | 0.19 |
| Average absorbance change amount in a | 0.003 | 0.001 | — | — | 0.059 | — | — |
| wavelength range of 400 nm to 800 | | | | | | | |
| nm during electron beam irradiation | | | | | | | |
| [in terms of thickness of 100 μm] | | | | | | | |
| K_{IC} [MPa · m^{1/2}] | 0.84 | 0.85 | 0.86 | 0.85 | 0.73 | 0.76 | 0.77 |
| Transmittance at 100 μm at wavelength of 400 nm | 87 | 87 | 90 | 90 | 92 | 91 | 87 |
| Transmittance at 100 μm at wavelength of 300 nm | 1 | 0 | 0 | 0 | 90 | 0 | 0 |
| Transmittance at 100 μm ([at wavelength | 86 | 87 | 90 | 90 | 2 | 91 | 87 |
| of 400]-[at wavelength of 300 nm]) | | | | | | | |
| Wavelength [nm] exhibiting transmittance | — | — | — | — | — | 343 | 353 |
| of 50% at thickness of 100 μm | | | | | | | |
| Transmittance at 50 μm [at wavelength of 400 nm] | 89 | 89 | 91 | 91 | 91 | — | — |
| Transmittance at 50 μm [at wavelength of 300 nm] | 10 | 1 | 1 | 4 | 90 | — | — |
| Transmittance at 50 μm ([at wavelength of | 79 | 88 | 89 | 87 | 1 | — | — |
| 400]-[at wavelength of 300 nm]) | | | | | | | |
| Wavelength [nm] exhibiting transmittance | 324 | 331 | 322 | 319 | <200 | — | — |
| of 50% at thickness of 50 μm | | | | | | | |
| Absolute value of warpage amount | 0.11 | 0.14 | 0.05 | 0.15 | 0.89 | 0.72 | 0.62 |
| δ/length in warpage direction of glass | | | | | | | |
| (length in warpage direction: 1000 mm, | | | | | | | |
| thickness: 0.1 mm) | | | | | | | |
| Absolute value of warpage amount | 0.09 | 0.11 | 0.04 | 0.12 | 0.69 | 0.56 | 0.48 |
| δ/length in warpage direction of glass | | | | | | | |
| (length in warpage direction: 1000 mm, | | | | | | | |
| thickness: 0.05 mm) | | | | | | | |
| Absolute value of warpage amount δ/length | 0.06 | 0.07 | 0.03 | 0.07 | 0.45 | 0.36 | 0.31 |
| in warpage direction of glass | | | | | | | |
| (length in warpage direction: 500 mm, | | | | | | | |
| thickness: 0.1 mm) | | | | | | | |
| Absolute value of warpage amount δ/length | 0.04 | 0.05 | 0.02 | 0.06 | 0.34 | 0.28 | 0.24 |
| in warpage direction of glass | | | | | | | |
| (length in warpage direction: 500 mm, | | | | | | | |
| thickness: 0.05 mm) | | | | | | | |

As shown in Tables 1 to 6, in Examples 1 to 39 as Inventive Examples, the specific gravity and the Young's modulus are about the same as those in Examples 40 to 42 as Comparative Examples, and the average absorbance change amount in the wavelength range of 400 nm to 800 nm during the electron beam irradiation is smaller, and the value of (absolute value of warpage amount δ/length in warpage direction of glass) is smaller than those in Examples 40 to 42 as Comparative Examples. From this result, it is found that, according to the glass according to the present embodiment, even when the glass is used for a solar cell in the case of being increased in size and reduced in thickness, the warpage of the solar cell can be effectively prevented.

As described above, the following matters are disclosed in the present description.

1. A glass, having a specific gravity of 2.2 to 2.7,
having a Young's modulus of 60 GPa or more,
having an average thermal expansion coefficient in a range of 50° C. to 200° C. of 2.0 to 6.0 (×10⁻⁶/K),
having a rectangular shape,
having a main surface with one side of 50 cm or more and 300 cm or less,
having a thickness of 0.01 mm or more and 0.5 mm or less,
having a total content of Li₂O, Na₂O, and K₂O of 0% to 3.5% in terms of mass % based on oxides, and
containing 0.1% to 10% of CeO₂ in terms of mass % based on oxides.

2. The glass according to the above 1, further containing, in terms of mass % based on oxides: 0.01% to 10% of TiO₂.

3. The glass according to the above 1 or 2, further containing, in terms of mass % based on oxides: 5% to 10% of TiO₂.

4. A glass, having a specific gravity of 2.2 to 2.7,
having a Young's modulus of 60 GPa or more,
having an average thermal expansion coefficient in a range of 50° C. to 200° C. of 2.0 to 6.0 (×10⁻⁶/K),
having a rectangular shape,
having a main surface with one side of 50 cm or more and 300 cm or less,
having a thickness of 0.01 mm or more and 0.5 mm or less, and
containing 5% to 10% of TiO₂ in terms of mass % based on oxides.

5. A glass containing, in terms of mass % based on oxides:
50% to 80% of SiO₂;
0% to 25% of B₂O₃;
0% to 30% of Al₂O₃; and
0.1% to 10% of CeO₂, and
having a total content of Li₂O, Na₂O, and K₂O of 0% to 3.5%,
having a rectangular shape,
having a main surface with one side of 50 cm or more and 300 cm or less, and
having a thickness of 0.01 mm or more and 0.5 mm or less.

6. A glass containing, in terms of mass % based on oxides:
50% to 80% of SiO₂;
0% to 25% of B₂O₃;
0% to 30% of Al₂O₃; and
5% to 10% of TiO₂, and
having a total content of Li₂O, Na₂O, and K₂O of 0% to 3.5%,
having a rectangular shape,
having a main surface with one side of 50 cm or more and 300 cm or less, and
having a thickness of 0.01 mm or more and 0.5 mm or less.

7. A glass containing, in terms of mass % based on oxides:
50% to 80% of SiO₂;
0% to 25% of B₂O₃;
0% to 30% of Al₂O₃;
0.01% to 10% of TiO₂; and
0.1% to 10% of CeO₂, and
having a total content of Li₂O, Na₂O, and K₂O of 0% to 3.5%,
having a rectangular shape,
having a main surface with one side of 50 cm or more and 300 cm or less, and
having a thickness of 0.01 mm or more and 0.5 mm or less.

8. The glass according to any one of the above 5 to 7, having an average thermal expansion coefficient in a range of 50° C. to 200° C. of 2.0 to 6.0 (×10⁻⁶/K).

9. The glass according to any one of the above 1 to 8, having a total content of As₂O₃ and Sb₂O₃ of 0% or more and less than 0.25% in terms of mass % based on oxides.

10. The glass according to any one of the above 1 to 9, further containing, in terms of mass % based on oxides: 0.01% to 0.4% of SnO₂.

11. The glass according to any one of the above 1 to 10, having a content of BaO of 0% or more and 6.5% or less in terms of mass % based on oxides.

12. The glass according to any one of the above 1 to 11, having an average absorbance change amount in a wavelength range of 400 nm to 800 nm during electron beam irradiation of 0.01 or less in terms of a thickness of 100 μm.

13. The glass according to any one of the above 1 to 12, having a fracture toughness value (K_{IC}) of 0.78 MPa·m^{1/2} or more.

14. The glass according to any one of the above 1 to 13, having a value obtained by subtracting a light transmittance at a wavelength of 300 nm from a light transmittance at a wavelength of 400 nm of 50% or more.

15. The glass according to any one of the above 1 to 14, having a value E/ρ obtained by dividing a Young's modulus E (GPa) by a specific gravity ρ of 27.0 GPa or more.

16. The glass according to any one of the above 1 to 15, having a β-OH of 1.0 mm⁻¹ or less.

17. The glass according to any one of the above 1 to 16, including: a conductive film on at least one surface.

18. The glass according to any one of the above 1 to 17, including: an antireflection film on at least one surface.

19. A solar cell cover glass for a space satellite, containing: the glass according to any one of the above 1 to 18.

20. A UV-blocking glass, containing: the glass according to any one of the above 1 to 18.

21. An electron-beam shielding glass, containing: the glass according to any one of the above 1 to 18.

Note that, the present application is based on a Japanese Patent Application No. 2023-152237 filed on Sep. 20, 2023, contents of which are incorporated herein by reference.

1. A glass, having a specific gravity of 2.2 to 2.7,
having a Young's modulus of 60 GPa or more,
having an average thermal expansion coefficient in a range of 50° C. to 200° C. of 2.0 to 6.0 (×10⁻⁶/K),
having a rectangular shape,
having a main surface with one side of 50 cm or more and 300 cm or less,
having a thickness of 0.01 mm or more and 0.5 mm or less, and
satisfying at least one of the following conditions (i) and (ii);
(i) a content of TiO₂ is 0.01% to 10% in terms of mass % based on oxides,
(ii) a total content of Li₂O, Na₂O, and K₂O is 0% to 3.5%, and a content of CeO₂ is 0.1% to 10%, in terms of mass % based on oxides.

2. The glass according to claim 1,
having a total content of Li₂O, Na₂O, and K₂O of 0% to 3.5% in terms of mass % based on oxides, and
comprising 0.1% to 10% of CeO₂ in terms of mass % based on oxides.

3. The glass according to claim 2, further comprising, in terms of mass % based on oxides:
0.01% to 10% of TiO₂.

4. The glass according to claim 1, further comprising, in terms of mass % based on oxides:
5% to 10% of TiO₂.

5. A solar cell, comprising:
the glass according to claim 1.

6. A glass comprising, in terms of mass % based on oxides:
50% to 80% of SiO₂;
0% to 25% of B₂O₃;
0% to 30% of Al₂O₃; and
at least one selected from the group consisting of CeO₂ in an amount of 0.1% to 10% and TiO₂ in an amount of 0.01% to 10%, and
having a total content of Li₂O, Na₂O, and K₂O of 0% to 3.5% in terms of mass % based on oxides,
having a rectangular shape,
having a main surface with one side of 50 cm or more and 300 cm or less, and
having a thickness of 0.01 mm or more and 0.5 mm or less.

7. The glass according to claim 6, comprising, in terms of mass % based on oxides:
0.1% to 10% of CeO₂.

8. The glass according to claim 6, comprising, in terms of mass % based on oxides:
5% to 10% of TiO₂.

9. The glass according to claim 7, further comprising, in terms of mass % based on oxides:
0.01% to 10% of TiO₂.

10. The glass according to claim 6, having an average thermal expansion coefficient in a range of 50° C. to 200° C. of 2.0 to 6.0 (×10⁻⁶/K).

11. The glass according to claim 6, having a total content of As₂O₃ and Sb₂O₃ of 0% or more and less than 0.25% in terms of mass % based on oxides.

12. The glass according to claim 6, further comprising, in terms of mass % based on oxides:
0.01% to 0.4% of SnO₂.

13. The glass according to claim 6, having a content of BaO of 0% or more and 6.5% or less in terms of mass % based on oxides.

14. The glass according to claim 6, having an average absorbance change amount in a wavelength range of 400 nm to 800 nm during electron beam irradiation of 0.01 or less in terms of a thickness of 100 μm.

15. The glass according to claim 6, having a fracture toughness value (K_{IC}) of 0.78 MPa·m^{1/2} or more.

16. The glass according to claim 6, having a value obtained by subtracting a light transmittance at a wavelength of 300 nm from a light transmittance at a wavelength of 400 nm of 50% or more.

17. The glass according to claim 6, having a value E/ρ obtained by dividing a Young's modulus E (GPa) by a specific gravity ρ of 27.0 GPa or more.

18. The glass according to claim 6, having a β-OH of 1.0 mm⁻¹ or less.

19. The glass according to claim 6, comprising:
a conductive film on at least one surface.

20. The glass according to claim 6, comprising:
an antireflection film on at least one surface.
